(19) United States
(12) Patent Application Publication
(10) Pub. No.: US 2021/0349346 A1
(43) Pub. Date: Nov. 11, 2021

(54) METHODS FOR FABRICATING LIQUID CRYSTAL POLARIZERS

(71) Applicant: SHARP KABUSHIKI KAISHA, Sakai City (JP)

(72) Inventors: NATHAN JAMES SMITH, Oxford (GB); ANDREW ACREMAN, Oxford (GB); ENRICO ANGIONI, Oxford (GB); MIHO YAMADA, Sakai City (JP); AKIRA SAKAI, Sakai City (JP)

(21) Appl. No.: 16/870,219

(22) Filed: May 8, 2020

(51) Int. Cl. G02F 1/1335; G02B 5/30

(52) U.S. Cl. CPC G02F 1/133528; G02F 1/133632; G02B 5/3016

(57) ABSTRACT

A method of fabricating a reactive mesogen (RM) guest-host polarizer is disclosed. The method includes forming an RM guest-host polarizer material on a substrate that promotes a substantially uniform planar alignment configuration of the RM guest-host molecules, forming a temporary layer on the RM guest-host polarizer material to align RM guest-host molecules of the RM guest-host polarizer material in the substantially uniform planar alignment configuration, performing polymerization of the RM guest-host polarizer material, and removing the temporary layer from the RM guest-host polarizer. The temporary layer includes at least one of a temporary fluid layer, a temporary particulate layer, a temporary gaseous layer, a temporary vacuum layer, and a temporary alignment substrate layer.

### FIELD

The present disclosure relates to fabrication techniques of thin liquid crystal (LC) polarizers for use with display devices.

### BACKGROUND

Polarizers can be classified as either linear polarizers or circular polarizers. A circular polarizer is a combination of a linear polarizer and a quarter wave plate (QWP). Linear and circular polarizers are essential optical elements for most liquid crystal displays (LCDs).

Circular polarizers are important for emissive displays such as organic light emitting displays (OLEDs) and quantum dot light emitting displays (QLEDs) among others. Circular polarizers may be used for reducing unwanted ambient reflections from internal layers of a display in order to improve ambient contrast ratio.

Conventional linear polarizers used for display applications include a uniaxial stretched poly(vinyl alcohol) that has been impregnated with iodine or doped with dichroic dyes. Conventional linear polarizers exhibit excellent dichroic ratios (typically >50) but are relatively thick (about 100 μm). However, the thickness of conventional polarizers precludes their use for in-cell LCD applications in which a polarizer is deposited between substrates that form an LC cell. The thickness of conventional polarizers is also detrimental to the mechanical performance of flexible, bendable and curved displays.

Thinner linear polarizers that use a guest-host liquid crystal mixture have been proposed to address the thickness problem of conventional polarizers. A guest-host liquid crystal polarizer includes a dichroic dye “guest” and an LC “host” in which the LC host aligns the dichroic dye in a predetermined direction. The LC host may be a reactive mesogen (RM).

An RM is an LC that can be polymerized in order to form a solid film. The terms LC and RM may be used interchangeably. A guest-host LC polarizer layer is typically 1-10 μm (i.e., 10\hat{ }-6 meters) thick excluding substrate(s). Smectic LCs and smectic RMs enable guest-host LC polarizers with high dichroic ratios (i.e., ≥15).

WO2005/045485A1, U.S. Pat. No. 8,518,299B2, EP1682930B1, EP2159611B1 and EP1899751B1 each relate to smectic guest-host LC polarizers. U.S. Pat. No. 7,449,223 describes the addition of a co-polymer to an LC material for controlling molecular alignment of the LC at an air interface. “High-Contrast Thin-Film Polarizers by Photo-Crosslinking of Smectic Guest-Host Systems” (Advanced Materials, 2006, 18, 2412-2417, DOI: 10.1002/adma.200600355) describes materials and fabrication methods for smectic B guest-host polarizers. “Fabrication of planarly-oriented polycrystalline thin films of smectic liquid crystalline organic semiconductors” (Soft Matter, 2017, DOI: 10.1039/c7sm01303e) describes using a temporary poly(vinyl alcohol) (PVA) layer to obtain planar alignment of LC molecules.

FIG. 1 illustrates a coordinate system for providing pertinent terms of orientation used in implementations of the present disclosure. In FIG. 1, the axes x, y and z are orthogonal to each other. The angle between the x-axis and the y-axis is defined as the in-plane angle φ with the term “in-plane” signifying being in the plane of the display device. The angle between the x-axis (or y-axis) and the z-axis is the out-of-plane angle θ relative to the plane of the display device.

In FIG. 1, an illustrative rod-shaped molecule 2000 is shown as oriented within an RM guest-host polarizer layer with a viewing direction 1000 of a viewer along the z-axis. Planar alignment of the rod-shaped molecule 2000 occurs when the rod-shaped molecule is substantially constrained to the x-y plane (i.e., out-of-plane angle θ<10°). Planar alignment of the rod-shaped molecule 2000 occurs when the rod-shaped molecule has a uniform in-plane alignment angle φ. Vertical alignment of the rod-shaped molecule 2000 occurs when the rod-shaped molecule has an out-of-plane angle θ that is approximately 90° (e.g., out-of-plane angle θ>80°).

FIG. 2 illustrates a related coordinate system pertaining to the in-plane angle φ identified in FIG. 1. In particular, FIG. 2 shows a range of positioning of the in-plane angle φ with respect to a display device from the perspective of a viewing position relative to a generalized polarizer film and display device.

FIG. 3 illustrates a related art guest-host RM polarizer cell 300 having a guest-host mixture between two substrates. The guest-host RM polarizer cell 300 includes a first substrate 302, a first alignment layer 304, a guest-host polarizer layer 310, a second alignment layer 306, and a second substrate 308. The guest-host RM polarizer cell 300 has a predetermined thickness in the z-direction.

The guest-host polarizer layer 310 may include a host material having host molecules 312 (e.g., RM) and a guest material having guest molecules 314 (e.g., dichroic dye). For ease of understanding both the host molecules 312 and guest molecules 314 of the guest-host polarizer layer 310 are depicted by rod-shaped molecules, while other mixture components, such as a photoinitiator and a thermal polymerization inhibitor, are omitted.

The first alignment layer 304 and second alignment layer 306 promote planar alignment of the guest-host polarizer layer 310 such that θ<10° and φ is a constant predetermined value. The RM guest-host mixture is polymerized to form a solid film.

Correct alignment of the guest-host smectic phase in FIG. 3 is achieved by aligning the guest-host smectic phase and having the two substrates with associated planar alignment layers that together form the guest-host RM polarizer cell 300. However, the guest-host RM polarizer cell 300 in FIG. 3 is undesirable for many display applications since both substrates 302 and 308 are used to align the guest-host polarizer layer 310 material, which precludes using the guest-host RM polarizer cell 300 for in-cell polarizer LCD applications. In addition, using two substrates to align the guest-host polarizer material is highly undesirable for flexible, bendable and curved display applications due to excessive thickness, excessive mechanically rigidity or parallax problems.

FIG. 4 illustrates a related art guest-host RM polarizer film 400 having a guest-host mixture in a smectic phase formed on a substrate. The guest-host RM polarizer film 400 includes a substrate 402, an alignment layer 404, and a guest-host polarizer layer 410. The alignment layer 404 promotes planar alignment of the guest-host mixture in the guest-host polarizer layer 410 (e.g., θ<10° and φ=a constant predetermined value). The guest-host polarizer layer 410 is deposited onto the substrate, for example, via a coating process, and polymerized to form a solid film.

As illustrated in FIG. 4, planar alignment of the guest-host smectic phase molecules is achieved near an interface 496 between the substrate 402 with the alignment layer 404 and the guest-host polarizer layer 410 (e.g., on the substrate-side), but vertical alignment of the guest-host smectic LC phase is achieved at an air interface 498 between the guest-host polarizer layer 410 and air.

As illustrated in FIG. 4, host molecules 412 and guest molecules 414 of the guest-host polarizer layer 410 often adopt unwanted non-planar alignment near the air interface 498, such as vertical alignment where the host molecules 412 and guest molecules 414 have vertical alignment along the z-direction near the air interface 498. In other words, the host molecules 412 and guest molecules 414 form a splayed configuration in the film thickness direction (e.g., the z-direction).

Vertical alignment of the guest-host smectic LC phase at the air interface 498 is highly undesirable because the optical qualities (e.g., transmission, contrast ratio, dichroic ratio, etc.) of the guest-host RM polarizer film 400 are degraded significantly.

While the guest-host RM polarizer film 400 having a single substrate configuration in FIG. 4 has a reduced thickness as compared to the guest-host RM polarizer cell 300 of FIG. 3 having two substrates, the guest-host RM polarizer film 400 has degraded optical qualities (e.g., reduced dichroic ratio) due to the splayed configuration of guest-host molecules thus rendering it unfit for display applications.

For guest-host polarizers to be suitable for display applications, uniform planar alignment of the guest-host RM polarizer absorption axis is required to be substantially constrained to the plane of the film device or display device at all positions in the thickness direction (e.g., the z-direction) such that the polarizer absorption axis of the guest-host RM polarizer is substantially constrained to the x-y plane and has a uniform angle relative to the x-direction. In other words, the absorption axis of the guest-host RM polarizer has a constant alignment angle φ and is constrained to the x-y plane.

Therefore, a guest-host polarizer is needed to address problems associated with guest-host polarizers described previously.

### SUMMARY

According to a first aspect of the present disclosure, a method of fabricating a reactive mesogen (RM) guest-host polarizer includes forming an RM guest-host polarizer material on a substrate that promotes a substantially uniform planar alignment configuration of the RM guest-host molecules, forming a temporary layer on the RM guest-host polarizer material to align RM guest-host molecules of the RM guest-host polarizer material in the substantially uniform planar alignment configuration, performing polymerization of the RM guest-host polarizer material, and removing the temporary layer from the RM guest-host polarizer, where the temporary layer includes at least one of: a temporary fluid layer, a temporary particulate layer, a temporary gaseous layer, a temporary vacuum layer, and a temporary alignment substrate layer.

In an implementation of the first aspect, the RM guest-host polarizer material is formed on the substrate at a first temperature, the substrate having a first surface energy, and the temporary alignment substrate layer encapsulates the RM guest-host polarizer material, the temporary alignment substrate layer having a second surface energy lower than the first surface energy, the temporary alignment substrate layer also aligns the RM guest-host molecules in the substantially uniform planar alignment configuration.

In another implementation of the first aspect, the RM guest-host polarizer material is polymerized at a second temperature lower than the first temperature.

In yet another implementation of the first aspect, the polymerization of the RM guest-host polarizer material includes a photo-polymerization process that is performed through at least one of the substrate and the temporary layer pertaining to the RM guest-host polarizer material.

In yet another implementation of the first aspect, the substrate includes an arrangement of electrodes configured to apply an in-plane electric field across the RM guest-host polarizer molecules no later than while performing the polymerization of the RM guest-host polarizer material, and the electric field aligns the RM guest-host molecules in the substantially planar arrangement.

In yet another implementation of the first aspect, the temporary gaseous layer has a pressure that is below, the same as or above an atmospheric pressure.

In yet another implementation of the first aspect, the method further includes applying a magnetic field across the RM guest-host polarizer molecules no later than while performing the polymerization of the RM guest-host polarizer material.

In yet another implementation of the first aspect, the method further includes applying a rubbing process to a non-substrate side of the RM guest-host polarizer material no later than while performing the polymerization of the RM guest-host polarizer material.

In yet another implementation of the first aspect, a first layer of the RM guest-host polarizer molecules is deposited and polymerized, and a second layer of the RM guest-host polarizer molecules is deposited on the first layer and polymerized.

In yet another implementation of the first aspect, the forming of the RM guest-host polarizer material on the substrate is a deposition process including at least one of: a slot-die coating process, ink-jet printing process, a doctor blade coating process, and a spin coating process.

According to a second aspect of the present disclosure, a method of fabricating a reactive mesogen (RM) guest-host polarizer includes forming an RM guest-host polarizer material on a substrate that promotes a substantially uniform planar alignment configuration of the RM guest-host molecules, performing first polymerization of the RM guest-host polarizer material at a first temperature, wherein the RM guest-host polarizer material is in a nematic, a smectic A or a smectic C phase, and the guest-host polarizer material adopts the substantially uniform planar alignment configuration at a surface facing away from the substrate, and performing second polymerization of the RM guest-host polarizer material at a second temperature lower than the first temperature, where the RM guest-host polarizer material is not in the nematic, the smectic A, or the smectic C phase.

In an implementation of the second aspect, at least one of the first polymerization and the second polymerization includes a photo-polymerization process.

In another implementation of the second aspect, the substrate includes an arrangement of electrodes configured to apply an in-plane electric field across the RM guest-host polarizer molecules no later than while performing the polymerization of the RM guest-host polarizer material, and the electric field aligns the RM guest-host molecules in the substantially planar arrangement.

In yet another implementation of the second aspect, the method further includes applying a magnetic field across the RM guest-host polarizer molecules no later than while performing the first or second polymerization of the RM guest-host polarizer material.

In yet another implementation of the second aspect, the method further includes applying a rubbing process to a non-substrate side of the RM guest-host polarizer material no later than while performing the first or second polymerization of the RM guest-host polarizer material.

In yet another implementation of the second aspect, the forming of the RM guest-host polarizer material on the substrate is a deposition process including at least one of a slot-die coating process, ink-jet printing, a doctor blade coating process, and a spin coating process.

According to a third aspect of the present disclosure, a method of fabricating a reactive mesogen (RM) guest-host polarizer includes forming an RM guest-host polarizer material on a substrate that promotes a substantially uniform planar alignment configuration of the RM guest-host molecules, the substrate having an arrangement of electrodes, applying an in-plane electric field to the arrangement of electrodes to induce the substantially uniform planar alignment configuration of RM guest-host polarizer molecules in the RM guest-host polarizer material, performing polymerization of the RM guest-host polarizer material.

In an implementation of the third aspect, the polymerization of the RM guest-host polarizer material includes a photo-polymerization process.

In another implementation of the third aspect, the method further includes applying a magnetic field across the RM guest-host polarizer molecules no later than while performing the polymerization of the RM guest-host polarizer material.

In yet another implementation of the third aspect, the forming of the RM guest-host polarizer material on the substrate is a deposition process including at least one of a slot-die coating process, ink-jet printing process, a doctor blade coating process. and a spin coating process.

### BRIEF DESCRIPTION OF DRAWINGS

FIG. 1 illustrates a coordinate system for providing pertinent terms of orientation used in implementations of the present disclosure.

FIG. 2 illustrates a related coordinate system pertaining to the in-plane angle φ identified in FIG. 1.

FIG. 3 illustrates a related art guest-host RM polarizer cell having two substrates.

FIG. 4 illustrates a related art guest-host RM polarizer film.

FIG. 5 illustrates a guest-host smectic phase polarizer device having a single substrate configuration, in accordance with an example implementation of the present disclosure.

FIGS. 6A, 6B, 6C, 6D, 6E, and 6F each illustrate a deposition substrate of an RM guest-host polarizer device, in accordance with example implementations of the present disclosure.

FIG. 7 illustrates a flowchart of a method of manufacturing an RM guest-host polarizer device using a temporary alignment substrate, in accordance with an example implementation of the present disclosure.

FIG. 8A illustrates roll-to-roll manufacturing equipment for an RM guest-host polarizer device in which a temporary alignment substrate is recycled (reused) by a continuous loop arrangement, in accordance with an example implementation of the present disclosure.

FIG. 8B illustrates roll-to-roll manufacturing equipment for an RM guest-host polarizer device in which a temporary alignment substrate is not recycled (not re-used), in accordance with an example implementation of the present disclosure.

FIG. 8C illustrates a flowchart of the manufacturing methods illustrated in FIGS. 8A and 8B.

FIGS. 9A, 9B, 9C, and 9D each illustrate a temporary alignment substrate used during the manufacturing processes described with reference to FIGS. 8A, 8B, and 8C, in accordance with example implementations of the present disclosure.

FIGS. 10A, 10B, 10C, and 10D illustrate a manufacturing process in which a temporary fluid layer is used on top of an RM guest-host polarizer material in order to obtain a desired molecular configuration of an RM guest-host polarizer device, in accordance with an example implementation of the present disclosure.

FIGS. 11A, 11B, 11C, and 11D illustrate a manufacturing process in which a phase separation process is used to form a temporary fluid layer on top of an RM guest-host polarizer material in order to obtain a desired molecular configuration of an RM guest-host polarizer device, in accordance with an example implementation of the present disclosure.

FIGS. 12A, 12B, 12C, and 12D illustrate a manufacturing process in which a temporary layer of particles is used on top of an RM guest-host polarizer material in obtain a desired molecular configuration of an RM guest-host polarizer device, in accordance with an example implementation of the present disclosure.

FIG. 13 illustrates a flowchart of a method of manufacturing an RM guest-host polarizer device, in accordance with an example implementation of the present disclosure.

FIGS. 14A, 14B, 14C, and 14D illustrate a manufacturing process that uses a patterned polymerization procedure of an RM guest-host polarizer material in order to obtain a desired molecular configuration of an RM guest-host polarizer device, in accordance with an example implementation of the present disclosure.

FIGS. 15A, 15B, 15C, and 15D illustrate a manufacturing process that uses a surface polymerization procedure of an RM guest-host polarizer material in order to obtain a desired molecular configuration of an RM guest-host polarizer device, in accordance with an example implementation of the present disclosure.

FIGS. 16A, 16B, 16C, and 16D illustrate a manufacturing process that uses a partial polymerization procedure of an RM guest-host polarizer material in order to obtain a desired molecular configuration of an RM guest-host polarizer device, in accordance with an example implementation of the present disclosure.

FIGS. 17A, 17B, 17C, and 17D illustrate a manufacturing process that uses a partial polymerization procedure of an RM guest-host polarizer material in order to obtain a desired molecular configuration of an RM guest-host polarizer device, in accordance with an example implementation of the present disclosure.

FIGS. 18A, 18B, 18C, and 18D illustrate a manufacturing process that uses a controlled atmosphere above an RM guest-host polarizer material in order to obtain a desired molecular configuration of an RM guest-host polarizer device, in accordance with an example implementation of the present disclosure.

FIGS. 19A, 19B, 19C, and 19D illustrate a manufacturing process that uses a photo-polymerization exposure procedure in which an RM guest-host polarizer material is photo-polymerized via an exposure from the substrate side in order to obtain a desired molecular configuration of an RM guest-host polarizer device, in accordance with an example implementation of the present disclosure.

FIG. 20A is a schematic diagram of a display structure having an OLED display with a circular polarizer, in accordance with an example implementation of the present disclosure.

FIG. 20B is a schematic diagram of a display structure having an OLED display with a circular polarizer, in accordance with another example implementation of the present disclosure.

FIG. 20C is a schematic diagram of a display structure having an OLED display with a circular polarizer, in accordance with another example implementation of the present disclosure.

FIG. 20D is a schematic diagram of a display structure having an OLED display with a circular polarizer, in accordance with another example implementation of the present disclosure.

FIG. 21 is a schematic diagram of a display structure having Liquid Crystal Display (LCD) with an in-cell polarizer, in accordance with an example implementation of the present disclosure.

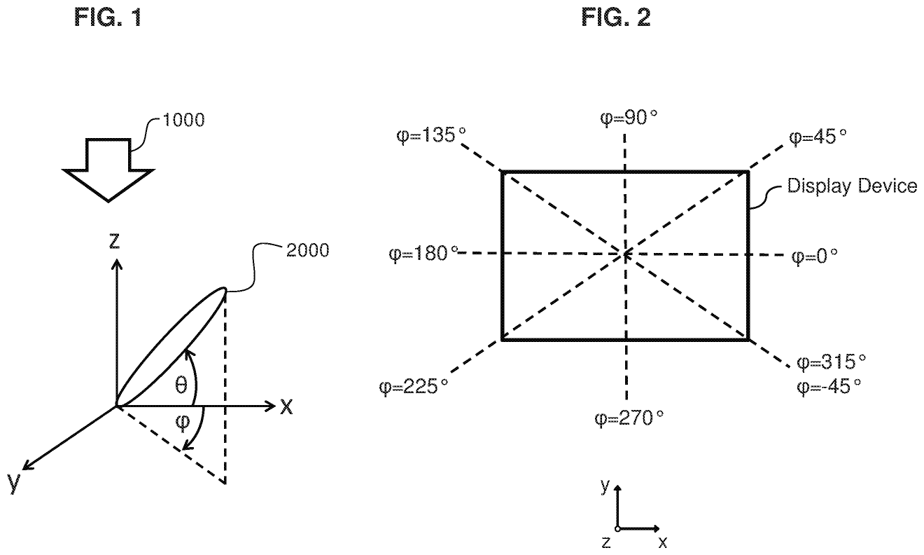

### DESCRIPTION

Implementations of the present disclosure will now be described with reference to the drawings in which reference numerals are used to refer to like elements throughout. It will be understood that the figures are not necessarily to scale.

The present disclosure provides manufacturing methods for a high-quality guest-host RM polarizer device in which the host is a smectic phase LC. The manufacturing methods achieve a guest-host polarizer on a single substrate in order to reduce thickness.

The guest-host polarizer of the present disclosure may be used with a quarter wave plate retarder (λ/4) to form a circular polarizer that may in turn be used for reducing unwanted ambient reflections from internal layers of a display (e.g., an OLED, a LCD, etc.). The single substrate guest-host polarizer of the present disclosure may be disposed between substrates of an LCD in order to form an in-cell polarizer.

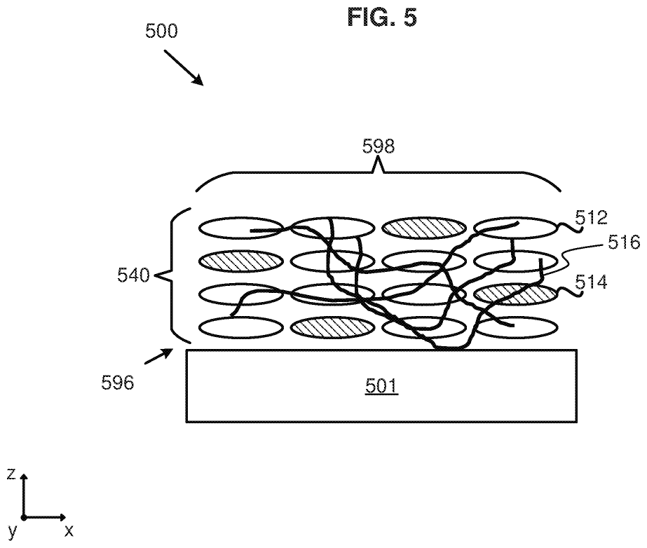

FIG. 5 illustrates a guest-host smectic phase polarizer device 500 having a single substrate configuration, in accordance with an example implementation of the present disclosure. As illustrated in FIG. 5, the guest-host smectic phase polarizer device 500 includes a deposition substrate 501 and a guest-host polarizer layer 540. In one implementation, the guest-host smectic phase polarizer device 500 with a single substrate configuration is a guest-host LC/RM polarizer. In various implementations of the present disclosure, a guest-host smectic phase polarizer device may be also referred to as an RM guest-host polarizer device.

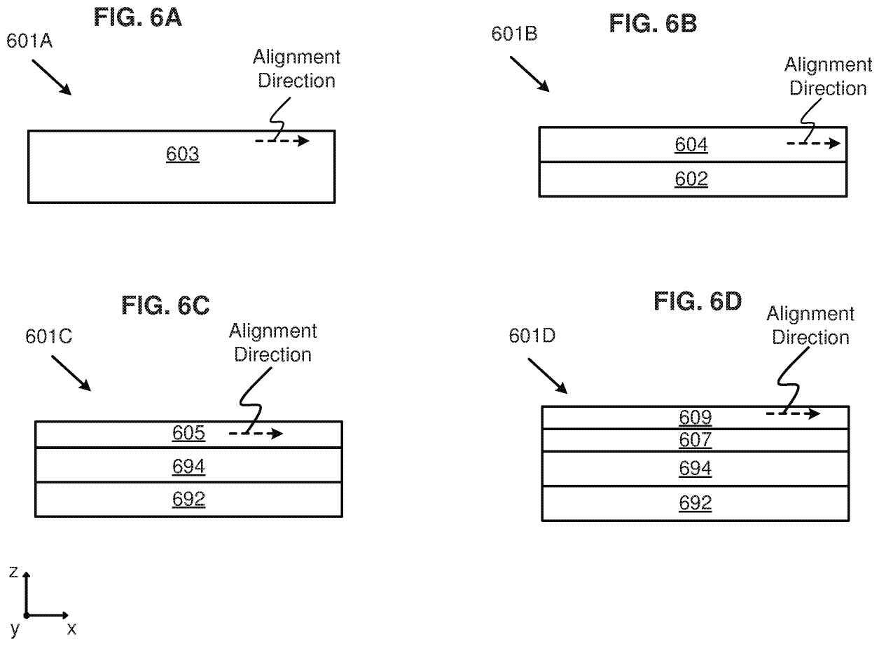

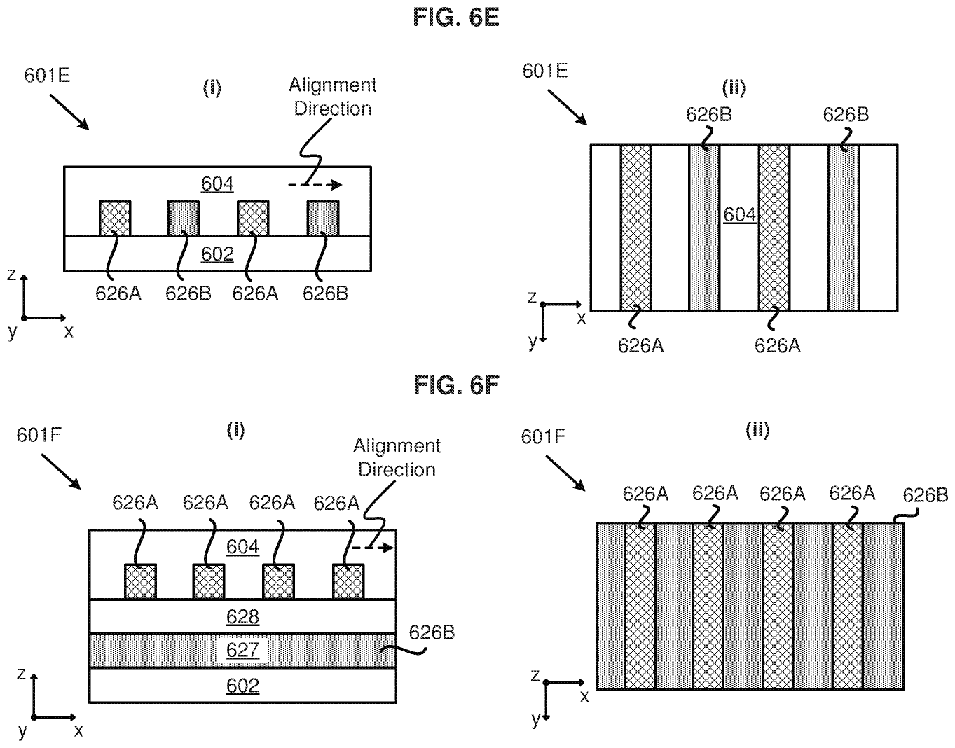

In the present implementation, the deposition substrate 501 promotes and/or is configured to promote a substantially uniform planar alignment configuration of RM guest-host molecules of the RM guest-host polarizer material in the guest-host polarizer layer 540. As discussed with reference to FIGS. 6A through 6F below, the deposition substrate 501 may include one or more sublayers.

With reference to FIG. 5, the RM guest-host polarizer material includes host molecules 512 and guest molecules 514, which are polymerized in the guest-host polarizer layer 540. The host molecules 512 are reactive mesogen molecules. The reactive mesogen molecules have at least one reactive group. In general, the host molecules 512 may have 1, 2 or 3 reactive groups. Upon illumination by UV radiation, the host molecules polymerize forming a solid film that is robust to environmental conditions. During the polymerization, chemical bonds are formed between the host molecules. The host molecules may be crosslinked by the UV exposure.

As shown in FIG. 5, the host molecules 512 and guest molecules 514 are linked (e.g., crosslinked) through polymerization bonds 516. In the guest-host smectic phase polarizer device 500, the host molecules 512 and guest molecules 514 adopt a planar orientation at both a substrate-side interface 596 and an air interface 598. The out-of-plane angle θ of the host molecules 512 and guest molecules 514 may be less than 25°, and preferably less than 15° at all positions within the guest-host polarizer layer 540.

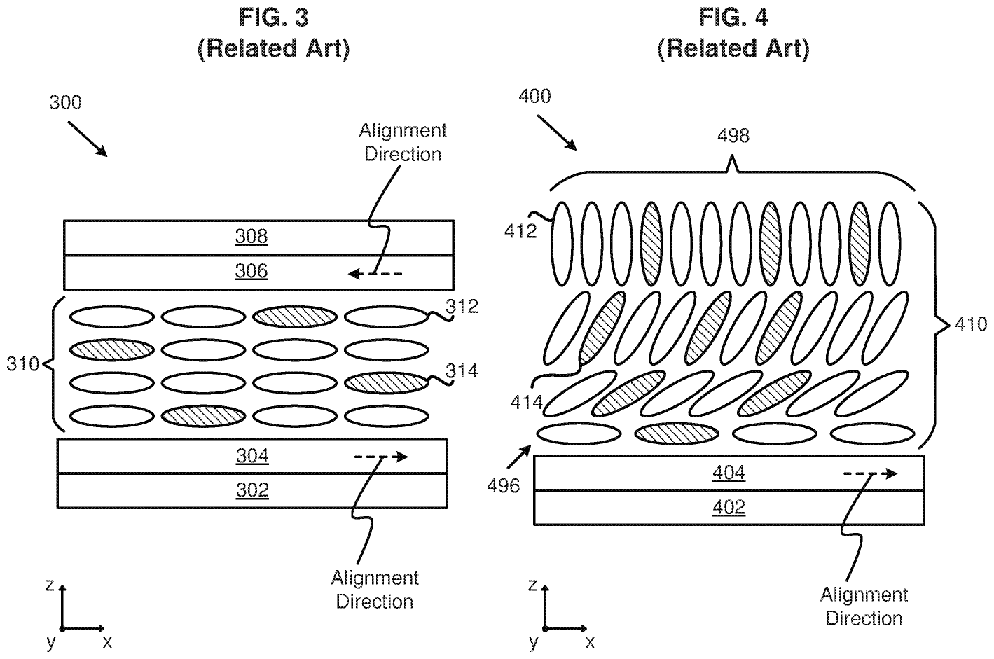

Unlike the related art guest-host RM polarizer cell 300 in FIG. 3 having two substrates, one on each side of the guest-host material, the guest-host smectic phase polarizer device 500 has a single substrate configuration, while the host molecules 512 and guest molecules 514 adopt the planar orientation on both the substrate-side interface 596 and the air interface 598 without a need for an additional substrate, thereby reducing the thickness of the polarizer device. Unlike the related art guest-host RM polarizer film 400 shown in FIG. 4, the guest-host polarizer layer 540 does not have a splayed configuration of guest-host molecules.

FIGS. 6A, 6B, 6C, 6D, 6E, and 6F each illustrate a deposition substrate of an RM guest-host polarizer device, in accordance with example implementations of the present disclosure. As illustrated in FIGS. 6A through 6F, a deposition substrate may include one or more sublayers.

In FIG. 6A, a deposition substrate 601A may include a single-layer substrate 603 having intrinsic alignment properties that promote a substantially uniform planar alignment configuration of RM guest-host molecules of an RM guest-host polarizer material. In other words, the single-layer substrate 603 is also the alignment layer for the guest-host polarizer molecules.

The single-layer substrate 603 shown in FIG. 6A may be glass or an optically clear and transparent polymer. The substrate shown in FIG. 6A may contain at least one of the following materials: polyethylene terephthalate (PET), Poly(methyl methacrylate) (i.e. PMMA), Polyethylene naphthalate (PEN), cyclo olefin polymer (COP), cyclo olefin copolymer (COC), polycarbonate (PC), high temperature polycarbonate (HTPC), polyetherimide (PEI), polyarcylate (PAR), polyphenylene sulfide (PPS), polyethersulfone (PES), polyether ether ketone (PEEK), polyimide (PI) or polyamide imide (PAI). Colorless and transparent polyimide (CPI) films and their analogues, including PAI and PEI, may be particularly well suited as the single-layer substrate 603 for an RM guest-host polarizer because of the following attributes: high optical transparency, colorless or very pale color, high thermal stability, excellent mechanical properties, and low thickness. High thermal stability is particularly important as many manufacturing processes employ a baking process for depositing one or more of the additional layers into the optical stack, and those baking processes may employ relatively high temperatures such as up to 280° C.

In FIG. 6B, a deposition substrate 601B may include a substrate 602 without intrinsic alignment properties and an alignment layer 604 that may assist the substrate 602 to promote a substantially uniform planar alignment configuration of RM guest-host molecules of an RM guest-host polarizer material. The alignment layer 604 may be permanently bonded to the substrate 602. The substrate 602 shown in FIG. 6B may be glass or an optically clear and transparent polymer as previously described.

In FIG. 6C, a deposition substrate 601C may include a substrate 605 formed on a carrier substrate 692 via a temporary bonding layer 694. The substrate 605 has intrinsic alignment properties that promote a substantially uniform planar alignment configuration of RM guest-host molecules of an RM guest-host polarizer material. In one implementation, the substrate 605 may substantially correspond to the single-layer substrate 603 having intrinsic alignment properties in FIG. 6A, but with a reduced thickness. In one implementation, the substrate 605 may be an ultra-thin substrate.

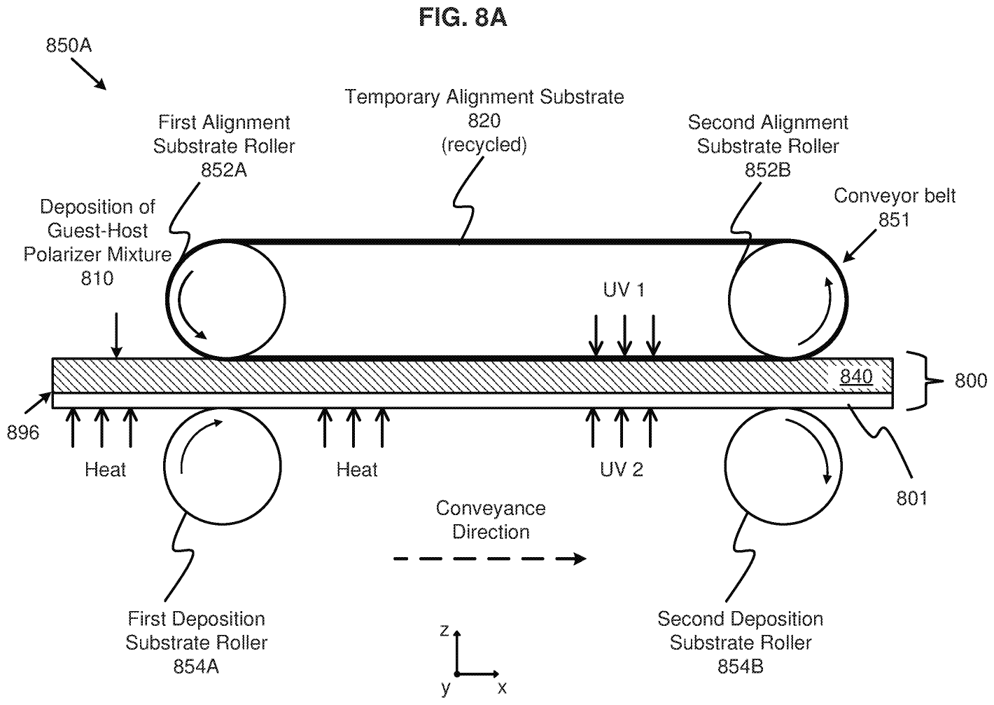

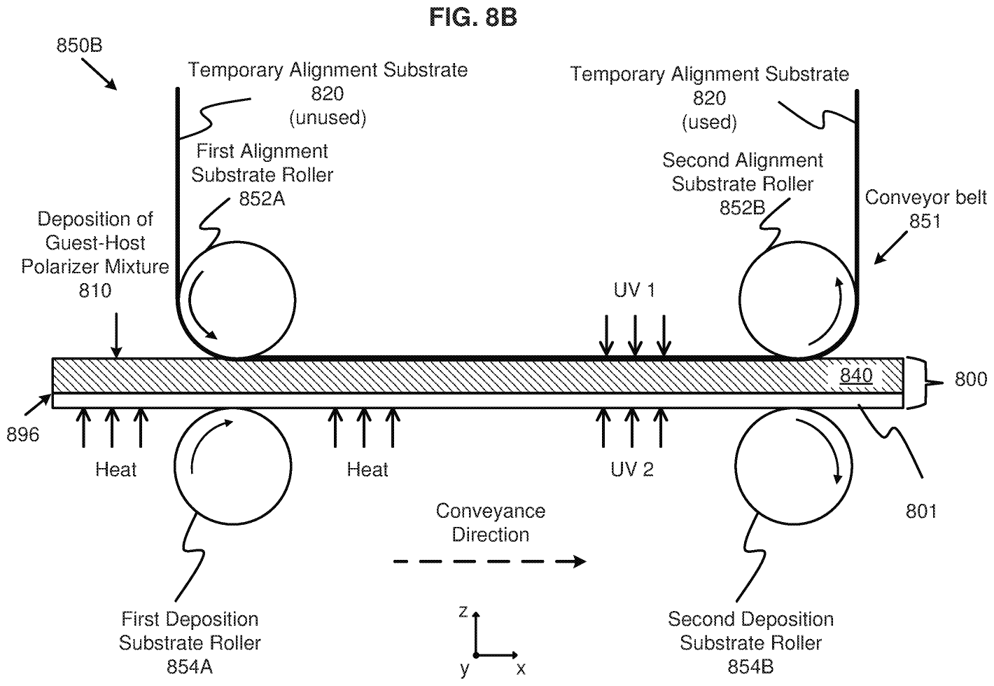

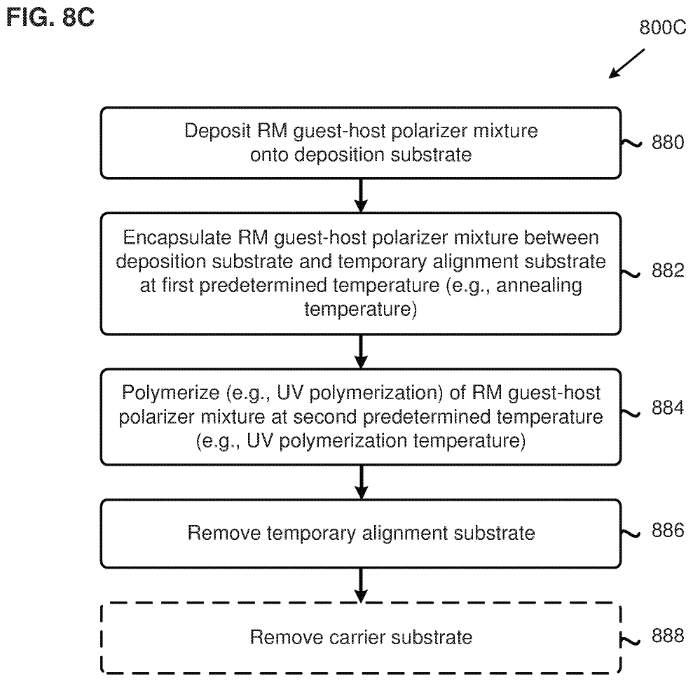

In one implementation, the substrate 605 is temporarily bonded to the carrier substrate 692 via the temporary bonding layer 694. The carrier substrate 692 may be removed after a polymerization procedure (e.g., as discussed in action 888 in FIG. 8C). The carrier substrate 692 may have a greater thickness (e.g., in the z-direction) than the substrate 605. The carrier substrate 692 is used to provide mechanical stability during the manufacturing process. The carrier substrate 692 may be glass or an optically clear and transparent polymer that has been previously described.

In FIG. 6D, a deposition substrate 601D may include an alignment layer 609 and a substrate 607 formed on a carrier substrate 692 via a temporary bonding layer 694. The substrate 607 does not have intrinsic alignment properties. The alignment layer 609 may assist the substrate 607 to promote a substantially uniform planar alignment configuration of RM guest-host molecules of an RM guest-host polarizer material. In one implementation, the substrate 607 may substantially correspond to the substrate 602 without intrinsic alignment properties in FIG. 6B, but with a reduced thickness. In one implementation, the alignment layer 609 may substantially correspond to the alignment layer 604 in FIG. 6B. In one implementation, the substrate 607 may be an ultra-thin substrate.

The alignment layer 609 may be permanently bonded to the substrate 607. In one implementation, the combination of the substrate 607 and the alignment layer 609 are temporarily bonded to the carrier substrate 692 via the temporary bonding layer 694. The carrier substrate 692 may be removed after a polymerization procedure (e.g., as discussed in action 888 in FIG. 8C). The carrier substrate 692 may have a greater thickness (e.g., in the z-direction) than the substrate 607. The carrier substrate 692 is used to provide mechanical stability during the manufacturing process. The carrier substrate 692 may be glass or an optically clear and transparent polymer that has been previously described.

With reference to FIGS. 6B and 6D, the alignment layer (e.g., alignment layer 604 or 609) associated with the deposition substrate (e.g., substrate 602 or 607 without intrinsic alignment properties) may be a reactive alignment layer, for example, the reactive alignment layer may contain chemical groups, such as acrylate groups or similar, that may be polymerized. The reactive alignment layer may form chemical bonds with the guest-host polarizer material during the photo-polymerization procedure, thus ensuring strong adhesion of the guest-host polarizer material to the reactive alignment layer.

The surface of the deposition substrate that is in contact with the RM guest-host material may have a larger surface energy than the surface of the temporary alignment substrate that is in contact with the RM guest-host material on the non-substrate side. The advantage of a larger surface energy on the deposition substrate surface than on the temporary alignment substrate is that after the guest-host material has been polymerized, the guest-host material will be more firmly adhered to the deposition substrate thus enabling the temporary alignment substrate to be easily removed from the polymerized RM guest-host layer (e.g., after the second alignment substrate roller 852B in FIGS. 8A and 8B). In other words, because of the difference in surface energies, the polymerized RM guest-host material is adhered more strongly to the deposition substrate than the temporary alignment substrate and thus enabling the temporary alignment substrate to be removed while leaving the polymerized RM guest-host material adhered to the deposition substrate.

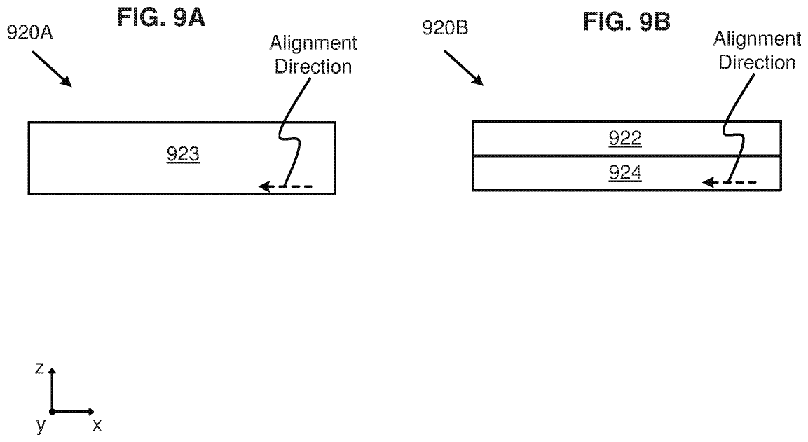

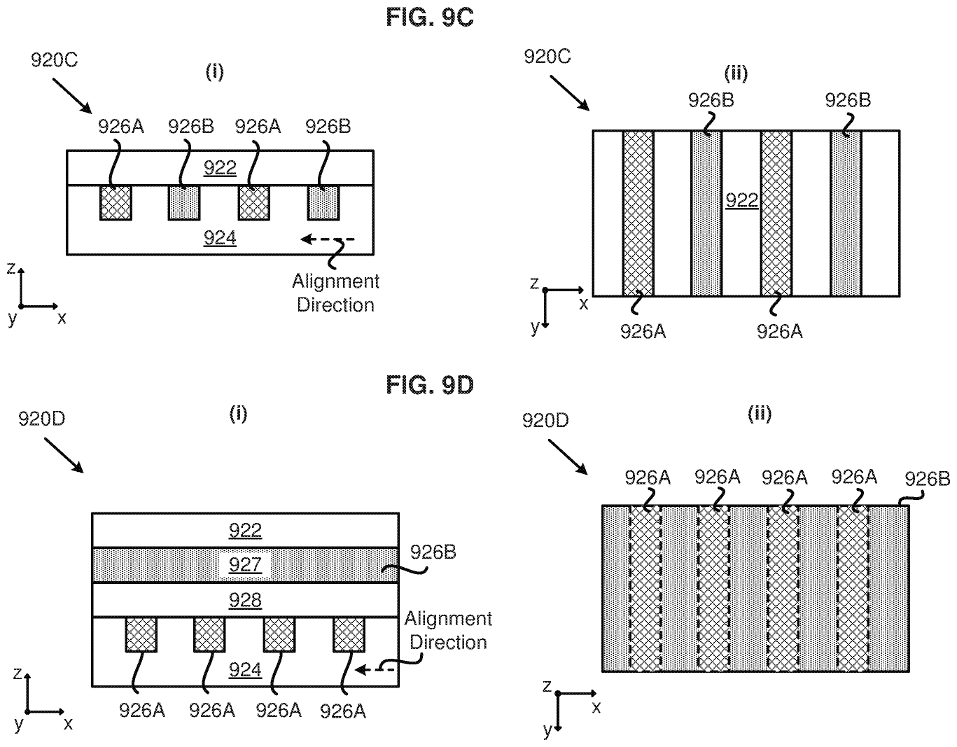

With reference FIGS. 6A and 9A, dissimilar surface energies between a deposition substrate and a temporary alignment substrate may be achieved by using different materials for the deposition substrate and the temporary alignment substrate.

With reference FIGS. 6A through 6D and FIGS. 9A through 9B, dissimilar surface energy strengths between a deposition substrate and a temporary alignment substrate may be achieved by using different alignment materials deposited onto the deposition substrate and the temporary alignment substrate.

With reference to FIGS. 6E and 6F, deposition substrates with electrodes are disclosed. In FIGS. 6E and 6F, deposition substrates 601E and 601F each include one or more electrodes that enable an in-plane electric field to be applied across the RM guest-host polarizer material (e.g., shown in FIG. 5). The in-plane electric fields are used to orientate the RM guest-host polarizer molecules before and/or during a polymerization process in order to obtain substantially uniform planar alignment of the guest-host polarizer molecules as depicted in FIG. 5. In general, in-plane electric fields have a large component of the electric field confined to the x-y plane.

With reference to FIG. 6E-(i), the deposition substrate 601E includes the substrate 602, the alignment layer 604, and electrode portions 626A and 626B between the substrate 602 and the alignment layer 604. The alignment layer 604 is in contact with the electrode portions 626A and 626B and the substrate 602. The substrate 602 may be glass or an optically clear and transparent polymer as described previously.

With reference to FIGS. 6E-(i) and 6E-(ii), the first electrode portions 626A and second electrode portions 626B are spaced apart in a first direction (x-direction as shown) and extend in a second direction (y-direction as shown). The first electrode portions 626A and second electrode portions 626B are patterned on a top surface of the substrate 602. The first electrode portions 626A may be electrically connected to a first voltage at a first node or electrode (not explicitly shown). The second electrode portions 626B may be electrically connected to a second voltage at a second node or electrode (not explicitly shown). The first electrode portions 626A and second electrode portions 626B are arranged in an interdigitated pattern as shown and enable an in-plane electrode field to be applied to the RM guest-host material (as shown in FIG. 5) before polymerization and/or during polymerization. It should be noted that in FIG. 6E-(ii) certain layers are rendered transparent in order to show the first electrode portions 626A and second electrode portions 626B.

The alignment direction of the alignment layer 604 in FIG. 6E may be parallel or perpendicular to the electrode portions 626A and 626B. Alternatively, the alignment direction of the alignment layer 604 in FIG. 6E may intersect the electrode portions 626A and 626B at a predetermined angle. The predetermined angle may be advantageous to enable a mono-domain of guest-host polarizer material. The predetermined angle may be less than 10° or greater than 80°. The predetermined angle is in the x-y plane and characterized by φ.

A magnetic field may be applied across the RM guest-host polarizer material (e.g., shown in FIG. 5) in order to orientate the RM guest-host polarizer molecules before and/or during the polymerization process in order to obtain substantially uniform planar alignment of the guest-host polarizer molecules as depicted in FIG. 5.

With reference to FIG. 6F-(i), the deposition substrate 601F includes the alignment layer 604, first electrode portions 626A, an insulation layer 628, a second electrode layer 627, and the substrate 602. The second electrode layer 627 is formed on the substrate 602. The first electrode portions 626A are formed (e.g., patterned) on the insulation layer 628 separating the first electrode portions 626A from the second electrode layer 627. The alignment layer 604 is in contact with the electrode portions 626A and the insulation layer 628. The substrate 602 may be glass or an optically clear and transparent polymer as described previously.

With reference to FIGS. 6F-(i) and 6F-(ii), the first electrode portions 626A are spaced apart in a first direction (x-direction as shown) and extend in a second direction (y-direction as shown). The first electrode portions 626A are patterned on a top surface of the substrate 602. The first electrode portions 626A may be electrically connected to a first voltage at a first node or electrode (not explicitly shown). The second electrode layer 627 may be unpatterned and have a single second electrode 626B extending along the x-y plane. The second electrode 626B may be electrically connected to a second voltage (not explicitly shown). It should be noted that, in FIG. 6F-(ii), certain layers are rendered transparent in order to show the first electrode portions 626A and second electrode 626B.

The substrates shown in FIGS. 6A through 6F may be used in a roll-to-roll process as described below with reference to FIGS. 8A, 8B, and 8C. Alternatively, a guest-host polarizer mixture may be deposited onto the substrates shown in shown in FIGS. 6A through 6F via a deposition processes, such as a spin coating process, a slot-die coating process, a dip coating process, ink-jet printing process, etc. Prior to and/or during a polymerization process of the RM guest-host polarizer material, an electric field may be applied between the first electrode portions 626A and the second electrode portions (or second electrode) 626B in order to obtain substantially uniform planar alignment of the guest-host polarizer molecules as depicted in FIG. 5.

It should be noted that each of the deposition substrates 601A, 601B, 601C, 601D, 601E, and 601F respectively shown and described in FIGS. 6A, 6B, 6C, 6D, 6E, and 6F may correspond to the deposition substrate 501 in FIG. 5. It should be noted that each of the deposition substrates 601A, 601B, 601C, 601D, 601E and 601F respectively shown and described in FIGS. 6A, 6B, 6C, 6D, 6E and 6F may correspond to the deposition substrate 801 described with reference to FIGS. 8A, 8B, and 8C.

The present disclosure includes several manufacturing methods to achieve the guest-host smectic phase polarizer device 500 that has the single substrate configuration and substantially uniform planar alignment of the guest-host molecules shown in FIG. 5. The manufacturing methods include, but are not limited to, using a temporary substrate (e.g., a solid or liquid substrate), using in-plane electric fields, using a two-stage polymerization process, and using a controlled atmosphere.

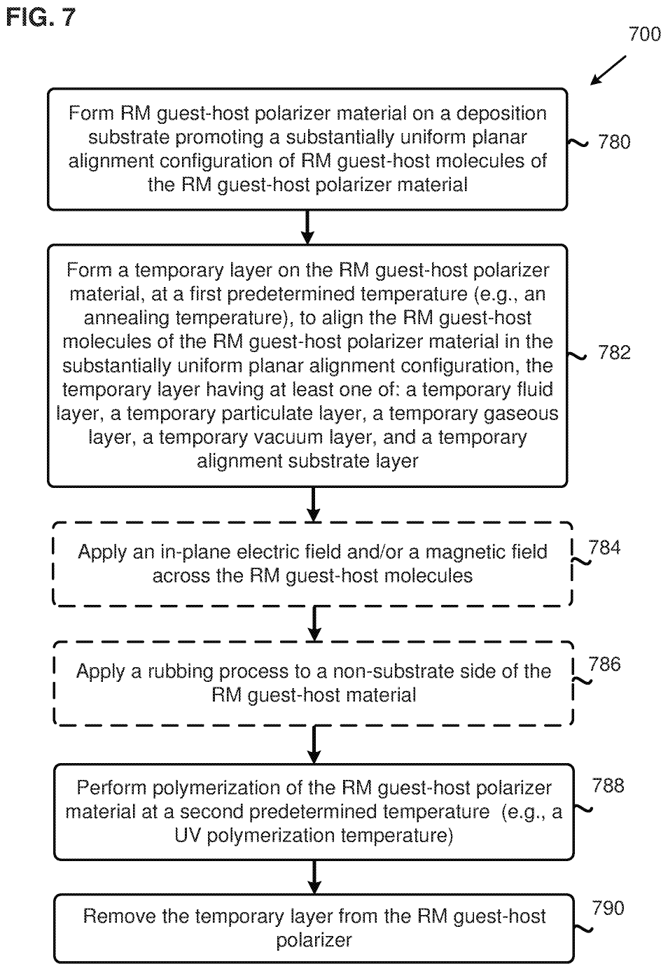

FIG. 7 illustrates a flowchart of a method of fabricating an RM guest-host polarizer device using a temporary alignment substrate (also referred to in the present disclosure as “a temporary layer”), in accordance with an example implementation of the present disclosure. In the present implementation, the flowchart 700 includes actions 780, 782, 784, 786, 788, and 790.

As shown in FIG. 7, action 780 includes forming an RM guest-host polarizer material on a deposition substrate that promotes a substantially uniform planar alignment configuration of RM guest-host molecules of the RM guest-host polarizer material.

Action 782 includes forming a temporary layer on the RM guest-host polarizer material, at a first predetermined temperature (e.g., an annealing temperature), to align the RM guest-host molecules of the RM guest-host polarizer material in the substantially uniform planar alignment configuration. The temporary layer may include at least one of: a temporary fluid layer, a temporary particulate layer, a temporary gaseous layer, a temporary vacuum layer, and a temporary alignment substrate layer.

Action 784 includes applying an in-plane electric field and/or a magnetic field across the RM guest-host molecules. For example, the deposition substrates 601E in FIG. 6E and 601F in FIG. 6F and the temporary alignment substrate layer 920C in FIG. 9C and 920D in FIG. 9D may be used to apply an in-plane electric field and/or a magnetic field is applied across the RM guest-host molecules.

Action 786 includes applying a rubbing process to a non-substrate side of the RM guest-host material.

Action 788 includes performing polymerization of the RM guest-host polarizer material at a second predetermined temperature (e.g., a UV polymerization temperature).

Action 790 includes removing the temporary layer from the RM guest-host polarizer.

It should be noted that actions 780 through 790 may be used during the manufacturing processes described with reference to FIGS. 8A-8C, 10A-10D, 11A-11D, and 12A-12D below. In some implementations, actions 784 and 786 may be optional.

FIG. 8A illustrates roll-to-roll manufacturing equipment for an RM guest-host polarizer device in which a temporary alignment substrate is recycled (reused) by virtue of a continuous loop arrangement, in accordance with an example implementation of the present disclosure.

The roll-to-roll manufacturing equipment 850A conveys an RM guest-host polarizer device from left to right using a mechanism of rollers. Upon exiting the roll-to-roll manufacturing equipment 850A (far right), the RM guest-host smectic phase polarizer device 800 includes a deposition substrate 801 (i.e., a single substrate configuration) and a polymerized RM guest-host polarizer layer 840. The polymerized guest-host molecules of the RM guest-host smectic phase polarizer device 800 have substantially uniform planar arrangement as shown by FIG. 5.

As shown in FIG. 8A, an RM guest-host polarizer mixture 810 is deposited onto the deposition substrate 801. The deposition substrate 801 promotes a substantially uniform planar alignment configuration of RM guest-host molecules of the RM guest-host polarizer mixture 810 at an interface 896 between the deposition substrate 801 and the RM guest-host polarizer mixture 810. In the present implementation, the deposition substrate 801 may correspond to the deposition substrate 501 in FIG. 5, the details of which are omitted for brevity.

As the deposition substrate 801 with the deposited RM guest-host polarizer mixture 810 is conveyed by the first deposition substrate roller 854A and the second deposition substrate roller 854B along the positive x-direction, a temporary alignment substrate 820 is formed on the RM guest-host polarizer mixture 810 at a predetermined temperature (e.g., an annealing temperature). The temporary alignment substrate 820 is carried by a conveyor belt 851 coupled to a first alignment substrate roller 852A and a second alignment substrate roller 852B. By forming the temporary alignment substrate 820 on the non-substrate side of the RM guest-host polarizer mixture 810, the RM guest-host polarizer mixture 810 is encapsulated between the deposition substrate 801 and the temporary alignment substrate 820.

As the encapsulated RM guest-host polarizer mixture 810 is further conveyed by the first deposition substrate roller 854A and the second deposition substrate roller 854B along the positive x-direction, a polymerization process is performed on the encapsulated RM guest-host polarizer mixture 810 at a second predetermined temperature (e.g., a UV polymerization temperature). In one implementation, a photo-polymerisation process may be used to polymerize the encapsulated RM guest-host polarizer mixture 810. The spectrum used for the photo-polymerization may contain visible light and/or UVA and/or UVB and/or UVC.

As shown in FIG. 8A, a UV photo-polymerisation process UV1 is performed on the non-substrate side of the encapsulated RM guest-host polarizer mixture 810. Optionally, the UV photo-polymerisation process UV2 may be also performed on the substrate side of the encapsulated RM guest-host polarizer mixture 810. As a result of the polymerization process, the RM guest-host polarizer mixture 810 is polymerized to form the polymerized RM guest-host polarizer layer 840, which is a solid film.

Thereafter, as the deposition substrate 801 with the polymerized RM guest-host polarizer layer 840 is conveyed along the positive x-direction passed the second alignment substrate roller 852B, the temporary alignment substrate is removed from the polymerized RM guest-host polarizer layer 840, as the temporary alignment substrate 820 is fixed to (e.g., stationary relative to) the conveyor belt 851, thus recycled for continued use.

As the RM guest-host smectic phase polarizer device 800 exits the roll-to-roll manufacturing equipment 850A, the RM guest-host smectic phase polarizer device 800 includes the deposition substrate 801 (e.g., a single substrate configuration) and the polymerized RM guest-host polarizer layer 840. In one implementation, the RM guest-host smectic phase polarizer device 800 has substantially the same structure as the guest-host smectic phase polarizer device 500 in FIG. 5.

FIG. 8B illustrates roll-to-roll manufacturing equipment for an RM guest-host polarizer device in which a temporary alignment substrate is not recycled (not reused), in accordance with an example implementation of the present disclosure. The roll-to-roll manufacturing equipment 850B conveys an RM guest-host polarizer device from left to right using a mechanism of rollers. Upon exiting the roll-to-roll manufacturing equipment 850B (far right), the RM guest-host smectic phase polarizer device 800 includes a deposition substrate 801 (i.e., a single substrate configuration) and a polymerized RM guest-host polarizer layer 840. The polymerized guest-host molecules of the RM guest-host smectic phase polarizer device 800 have substantially uniform planar arrangement as shown by FIG. 5.

In the present implementation, the roll-to-roll manufacturing equipment 850B operates in a substantially similar way as the roll-to-roll manufacturing equipment 850A in FIG. 8A, except the temporary alignment substrate is not recycled.

FIG. 8C illustrates a flowchart 800C of the manufacturing methods illustrated in FIGS. 8A and 8B. In the present implementation, the flowchart 800C includes actions 880, 882, 884, 886, and 888.

As shown in FIG. 8C, action 880 includes depositing the RM guest-host polarizer mixture 810 onto the deposition substate 801.

Action 882 includes encapsulating the RM guest-host polarizer mixture 810 between the deposition substrate 801 and the temporary alignment substrate 820 at the first predetermined temperature (e.g., annealing temperature).

Action 884 includes polymerizing (e.g., UV polymerization) the RM Guest-Host polarizer mixture 810 at a second predetermined temperature (e.g., UV polymerization temperature). The spectrum used for the photo-polymerization may contain visible light and/or UVA and/or UVB and/or UVC.

Action 886 includes removing the temporary alignment substrate 820.

In a case where a carrier substrate (e.g., the carrier substrate 692 with the temporary bonding layer 694 in FIGS. 6C and 6D) is used to carry an ultra-thin deposition substrate (e.g., the ultra-thin substrate 605 in FIG. 6C or the ultra-thin substrate 607 with the alignment layer 609 in FIG. 6D), the flowchart 800C further includes action 888, which removes the carrier substrate as well as the temporary bonding layer, such that only the ultra-thin deposition substrate remains. It should be understood that action 888 is optional in implementations where a carrier substrate is not used in conjunction with an ultra-thin deposition substrate.

The principal function of the deposition substrate 801 is to be the base layer upon which all other layers pertaining to the RM guest-host smectic phase polarizer device 800 are subsequently deposited. When the RM guest-host polarizer mixture 810 is deposited onto the deposition substrate 801, the RM guest-host polarizer mixture 810 may be deposited onto the deposition substrate 801 at a predetermined temperature characterized by the isotropic phase or nematic phase or smectic A phase or smectic C phase of the RM guest-host polarizer mixture 810. The RM guest-host polarizer mixture 810 and deposition substrate 801 are conveyed left to right and are encapsulated by the temporary alignment substrate 820. Both the temporary alignment substrate 820 and the deposition substrate 801 align the guest-host polarizer molecules of the RM guest-host polarizer mixture 810 in the same planar orientation. In other words, the guest-host polarizer molecules at the surface of the deposition substrate 801 and temporary alignment substrate 820 are substantially planar aligned and have the same azimuthal angle (same φ) and a tilt angle, θ, in the range −25°<θ<25° and preferably a tilt angle in the range −15°<θ<15°. The temporary alignment substrate 820 is a temporary solid surface for obtaining planar alignment of the RM guest-host polarizer mixture 810 while the RM guest-host polarizer mixture 810 is in a fluidic (i.e. not fully polymerized) state. The planar alignment of the RM guest-host polarizer mixture 810 is shown in detail by FIG. 5. In one implementation, polymerization of the RM guest-host polarizer mixture 810 is performed by photo-polymerization. Before polymerization, the RM guest-host polarizer mixture 810 is in a fluidic state. After polymerization, the RM guest-host polarizer mixture 810 is in solid state. Prior to the photo-polymerization and while the RM guest-host polarizer mixture 810 is encapsulated between the deposition substrate 801 and the temporary alignment substrate 820, the RM guest-host polarizer mixture 810 may be heated to a first predetermined temperature which may be the isotropic or nematic or smectic A or smectic C temperature of the RM guest-host polarizer mixture 810. Heating of the RM guest-host polarizer mixture 810 prior to the polymerization process is referred to as the annealing stage. The RM guest-host polarizer mixture 810 may be polymerized at a second predetermined temperature. The second predetermined temperature may be within, or below, a smectic phase temperature range of the RM guest-host polarizer mixture 810. In particular, the second predetermined temperature may be within, or below, a smectic X phase temperature where X is a high order smectic phase that may be, for example, B, F or I. The first predetermined temperature (e.g., annealing temperature) may be equal to or greater than the second predetermined temperature (e.g., photo-polymerisation temperature). The temporary alignment layer substrate 820 may be recycled as shown by FIG. 8A or may be of single use as shown by FIG. 8B.

FIGS. 9A, 9B, 9C, and 9D each illustrate a temporary alignment substrate used during the manufacturing processes described with reference to FIGS. 8A, 8B, and 8C, in accordance with example implementations of the present disclosure.

In FIG. 9A, a temporary alignment substrate 920A may include a single-layer substrate 923 having intrinsic alignment properties that can promote a substantially uniform planar alignment configuration of RM guest-host molecules of an RM guest-host polarizer material, for example, on the non-substrate side of the RM guest-host polarizer material. In one implementation, the single-layer substrate 923 may substantially correspond to the single-layer substrate 603 having intrinsic alignment properties in FIG. 6A. For example, the single-layer substrate 923 may include the same material as the single-layer substrate 603 in FIG. 6A. In another example, the single-layer substrate 923 may include different material than the single-layer substrate 603 in FIG. 6A. In one implementation, the alignment direction of the temporary alignment substrate 920A (e.g., negative x-direction) may be opposite of the alignment direction of the deposition substrate (e.g., positive x-direction).

In FIG. 9B, a temporary alignment substrate 920B may include a substrate 922 without intrinsic alignment properties and an alignment layer 924 that may assist the substrate 922 to promote a substantially uniform planar alignment configuration of RM guest-host molecules of an RM guest-host polarizer material, for example, on the non-substrate side of the RM guest-host polarizer material.

In one implementation, the substrate 922 without intrinsic alignment properties may substantially correspond to the substrate 602 without intrinsic alignment properties in FIG. 6B. In one implementation, the alignment layer 924 may substantially correspond to the alignment layer 604 in FIG. 6B. In one implementation, the alignment direction of the temporary alignment substrate 920B (e.g., negative x-direction) may be opposite of the alignment direction of the deposition substrate (e.g., positive x-direction).

With reference to FIGS. 9C and 9D, temporary alignment substrates with electrodes are disclosed. In FIGS. 9C and 9D, temporary alignment substrates 920C and 920D each include one or more electrodes that enable an in-plane electric field to be applied across the RM guest-host polarizer material (e.g., shown in FIGS. 8A and 8B). The in-plane electric fields are used to orientate the RM guest-host polarizer molecules before and/or during a polymerization process in order to obtain substantially uniform planar alignment of the guest-host polarizer molecules as depicted in FIGS. 8A and 8B. In general, in-plane electric fields have a large component of the electric field confined to the x-y plane.

With reference to FIG. 9C-(i), the temporary alignment substrate 920C includes the substrate 922, the alignment layer 924, and electrode portions 926A and 926B between the substrate 922 and the alignment layer 924. The alignment layer 924 is in contact with the electrode portions 926A and 926B and the substrate 922. The substrate 922 may be glass or an optically clear and transparent polymer as described previously.

With reference to FIG. 9C-(ii), the first electrode portions 926A and second electrode portions 926B are spaced apart in a first direction (x-direction as shown) and extend in a second direction (y-direction as shown). The first electrode portions 926A and second electrode portions 926B are patterned on a bottom surface of the substrate 922. The first electrode portions 926A may be electrically connected to a first voltage at a first node or electrode (not explicitly shown). The second electrode portions 926B may be electrically connected to a second voltage at a second node or electrode (not explicitly shown). The first electrode portions 926A and second electrode portions 926B are arranged in an interdigitated pattern as shown and enable an in-plane electrode field to be applied to the RM guest-host material (as shown in FIGS. 8A and 8B) before polymerization and/or during polymerization. It should be noted that in FIG. 9C-(ii) certain layers are rendered transparent in order to show the first electrode portions 926A and second electrode portions 926B.

The alignment direction of the alignment layer 924 in FIG. 9C may be parallel or perpendicular to the electrode portions 926A and 926B. Alternatively, the alignment direction of the alignment layer 924 in FIG. 9C may intersect the electrode portions 926A and 926B at a predetermined angle. The predetermined angle may be advantageous to enable a mono-domain of guest-host polarizer material. The predetermined angle may be less than 10° or greater than 80°. The predetermined angle is in the x-y plane and characterized by φ.

A magnetic field may be applied across the RM guest-host polarizer material (e.g., shown in FIGS. 8A and 8B) in order to orientate the RM guest-host polarizer molecules before and/or during the polymerization process in order to obtain substantially uniform planar alignment of the guest-host polarizer molecules as depicted in FIG. 5.

With reference to FIG. 9D-(i), the temporary alignment substrate 920D includes the alignment layer 924, first electrode portions 926A, an insulation layer 928, a second electrode layer 927, and the substrate 922. The second electrode layer 927 is formed on a bottom surface of the substrate 922. The first electrode portions 926A are formed (e.g., patterned) on a bottom surface of the insulation layer 928 separating the first electrode portions 926A from the second electrode layer 927. The alignment layer 924 is in contact with the electrode portions 926A and the insulation layer 928. The substrate 922 may be glass or an optically clear and transparent polymer as described previously.

With reference to FIG. 9D-(i) and FIG. 9D-(ii), the first electrode portions 926A are spaced apart in a first direction (x-direction as shown) and extend in a second direction (y-direction as shown). The first electrode portions 926A are patterned on a bottom surface of the insulation layer 928. The first electrode portions 926A may be electrically connected to a first voltage at a first node or electrode (not explicitly shown). The second electrode layer 927 may be unpatterned and having a single second electrode 926B extending along the x-y plane. The second electrode 926B may be electrically connected to a second voltage (not explicitly shown). It should be noted that, in FIG. 9D-(ii), certain layers are rendered transparent in order to show the first electrode portions 926A and second electrode 926B.

The substrates shown in FIGS. 9A through 9D may be used in a roll-to-roll process as described above with reference to FIGS. 8A, 8B, and 8C. Alternatively, a guest-host polarizer mixture may be deposited onto the substrates shown in shown in FIGS. 9A through 9D via a deposition processes, such as a spin coating process, a slot-die coating process, a dip coating process etc. Prior to and/or during a polymerization process of the RM guest-host polarizer material, an electric field may be applied between the first electrode portions 926A and the second electrode portions (or second electrode) 926B in order to obtain substantially uniform planar alignment of the guest-host polarizer molecules as depicted in FIG. 5.

It should be noted that each of the temporary alignment substrates 920A, 920B, 920C, and 920D respectively shown and described in FIGS. 9A, 9B, 9C, and 9D may correspond to the temporary alignment substrate 820 described with reference to FIGS. 8A, 8B, and 8C.

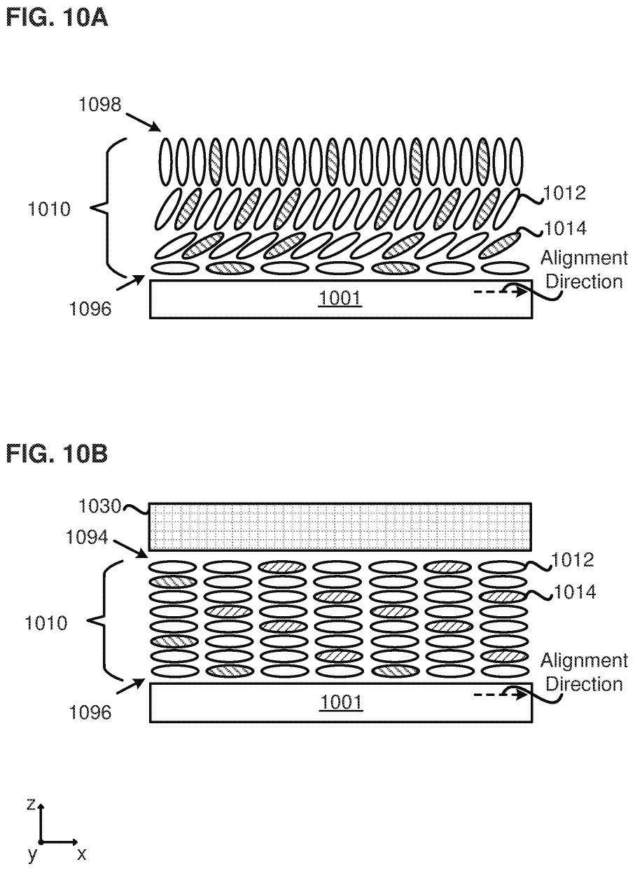

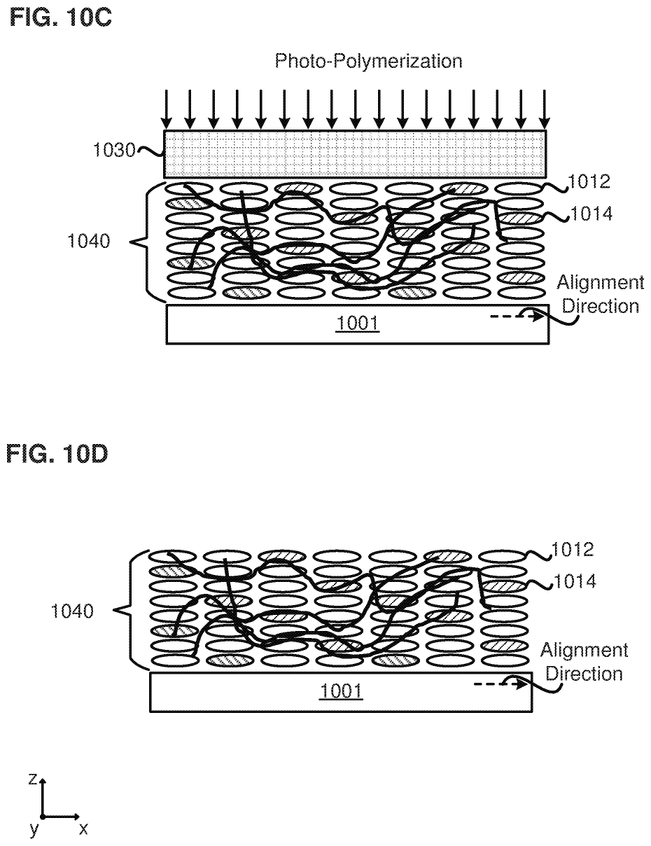

FIGS. 10A, 10B, 10C, and 10D illustrate a manufacturing process in which a temporary fluid layer is used on top of an RM guest-host polarizer material in order to obtain the desired molecular configuration of the RM guest-host polarizer device as depicted in FIG. 5.

With reference to FIG. 10A, an RM guest host polarizer material 1010 is deposited onto a deposition substrate 1001 via a deposition process, such as a spin coating process, a slot-die coating process, a dip coating process, an ink-jet printing process, etc. The deposition substrate 1001 may correspond to any of the deposition substrates 601A through 601F described previously. The RM guest-host polarizer material 1010 may include host polarizer molecules 1012 and guest polarizer molecules 1014. The deposition substrate 1001 causes the molecules of the RM guest-host polarizer material 1010 to adopt planar alignment in a predefined direction at the substrate-side interface 1096. At the air interface 1098 (e.g., non-substrate-side interface) the molecules of the RM guest-host polarizer material 1010 align vertically, causing a splayed molecular structure as shown in FIG. 4.

With reference to FIG. 10B, a temporary fluid layer 1030 is subsequently deposited on top of the RM guest-host polarizer material 1010, for example, via a process such as a spin coating process, a slot-die coating process, a dip coating process, an ink-jet printing process, etc. The temporary fluid layer 1030 may be a mixture of different fluids. The temporary fluid layer 1030 induces planar alignment of RM guest-host polarizer molecules at the fluid interface 1094 (e.g., non-substrate-side interface). The temporary fluid layer 1030 may be a liquid or a liquid crystal. The temporary fluid layer 1030 may be an organic or inorganic liquid or combination thereof and may also contain other chemicals such as salts or surfactants.

With reference to FIG. 10C, while the temporary fluid layer 1030 is in contact with the RM guest-host polarizer material 1010, the RM guest-host polarizer material 1010 is polymerized to become a polymerized RM guest-host material 1040. The polymerization may be a photo-polymerization process (as previously described). In another implementation, the polymerization may be a thermal polymerization process.

With reference to FIG. 10D, the temporary fluid layer 1030 is removed yielding a polymerized RM guest-host polarizer device as depicted in FIG. 5.

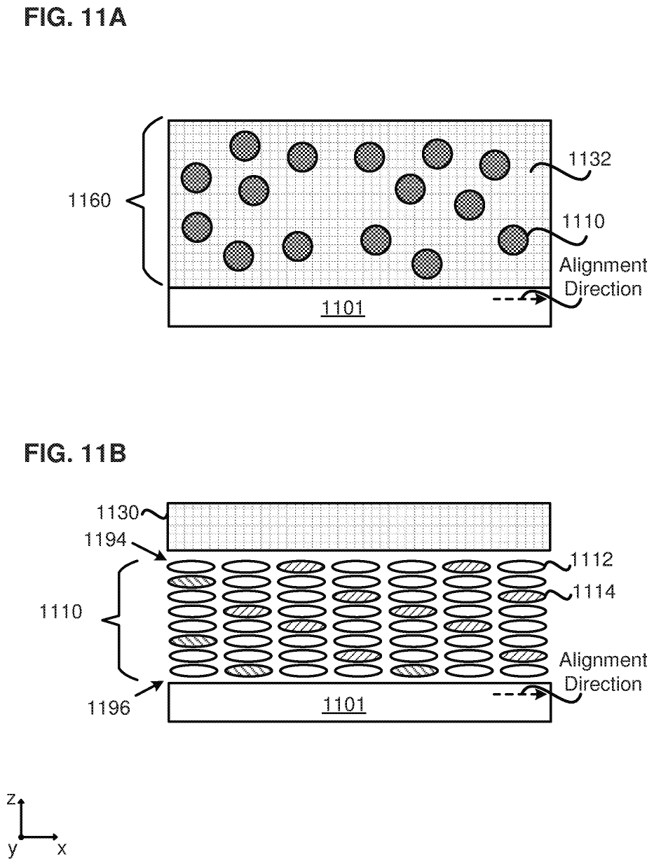

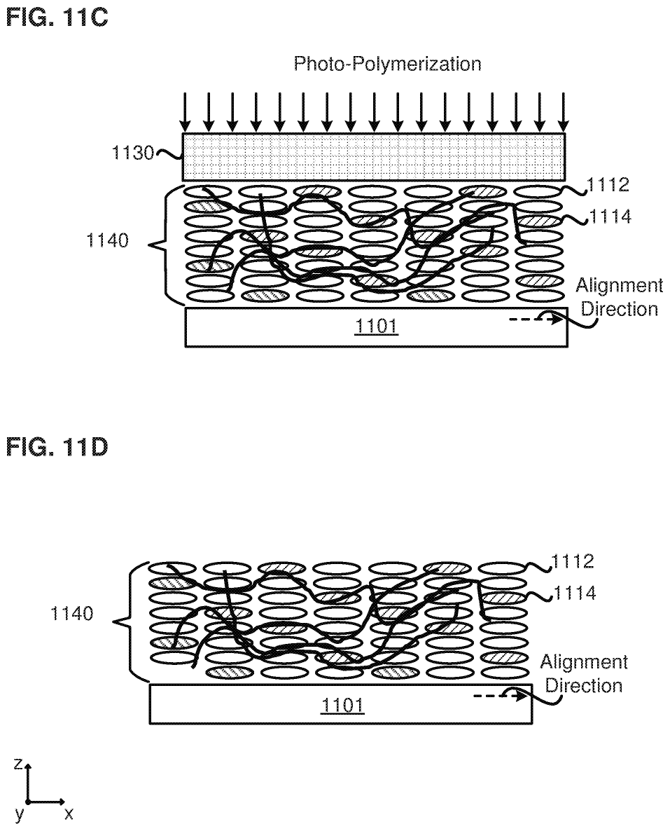

FIGS. 11A, 11B, 11C, and 11D illustrate a manufacturing process in which a phase separation process is used to form a temporary fluid layer on top of a RM guest-host polarizer material in order to obtain the desired molecular configuration of the RM guest-host polarizer device as depicted in FIG. 5.

With reference to FIG. 11A, a mixture 1160 of an RM guest-host polarizer material 1110 and fluid(s) 1132 is deposited onto a deposition substrate 1101 via a deposition process, such as a spin coating process, a slot-die coating process, a dip coating process etc. The mixture 1160 of the RM guest-host polarizer material 1110 and fluid(s) 1132 may form an emulsion.

With reference to FIG. 11B, the RM guest-host polarizer material 1110 and fluid(s) 1132 in the mixture 1160 phase separate so that a temporary fluid layer 1130 forms on top of the RM guest host polarizer material 1110. The RM guest-host polarizer material 1110 may include host polarizer molecules 1112 and guest polarizer molecules 1114. The deposition substrate 1101 may correspond to any of the deposition substrates 601A through 601F described previously. The deposition substrate 1101 causes the molecules of the RM guest-host polarizer material 1110 to adopt planar alignment in a predefined direction at the substrate-side interface 1196.

The temporary fluid layer 1130 induces substantially planar alignment of RM guest-host polarizer molecules at the fluid interface 1194 (e.g., non-substrate-side interface). The temporary fluid layer 1130 may be a liquid or a liquid crystal. The temporary fluid layer 1130 may be an organic or inorganic liquid or combination thereof and may also contain other chemicals such as salts or surfactants.

With reference to FIG. 11C, while the temporary fluid layer 1130 is in contact with the RM guest-host polarizer material 1110, the RM guest-host polarizer material 1110 is polymerized to become a polymerized RM guest-host material 1140. The polymerization may be a photo-polymerization process (as previously described). In another implementation, the polymerization may be a thermal polymerization process.

With reference to FIG. 11D, the temporary fluid layer 1130 is removed yielding a polymerized RM guest-host polarizer device as depicted in FIG. 5.

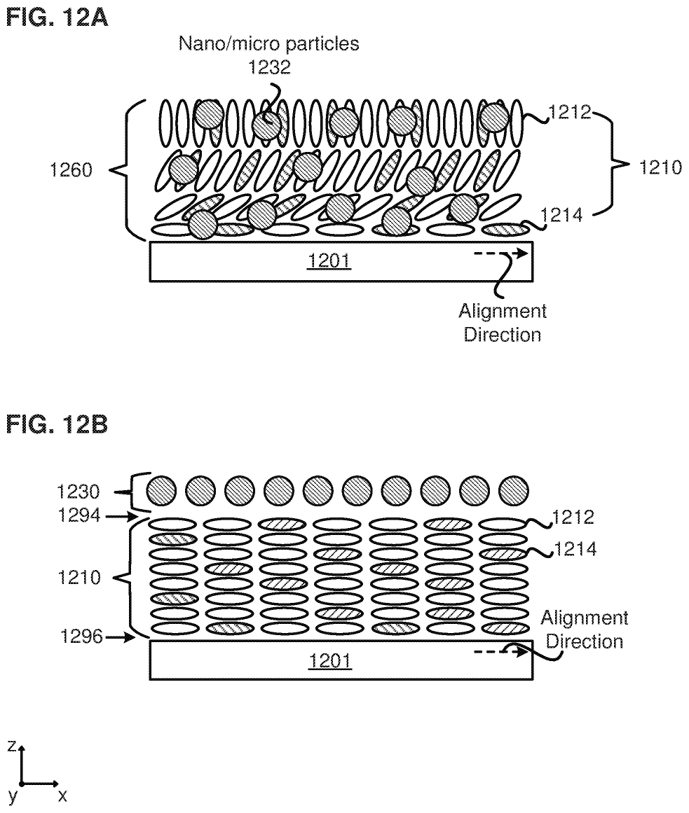

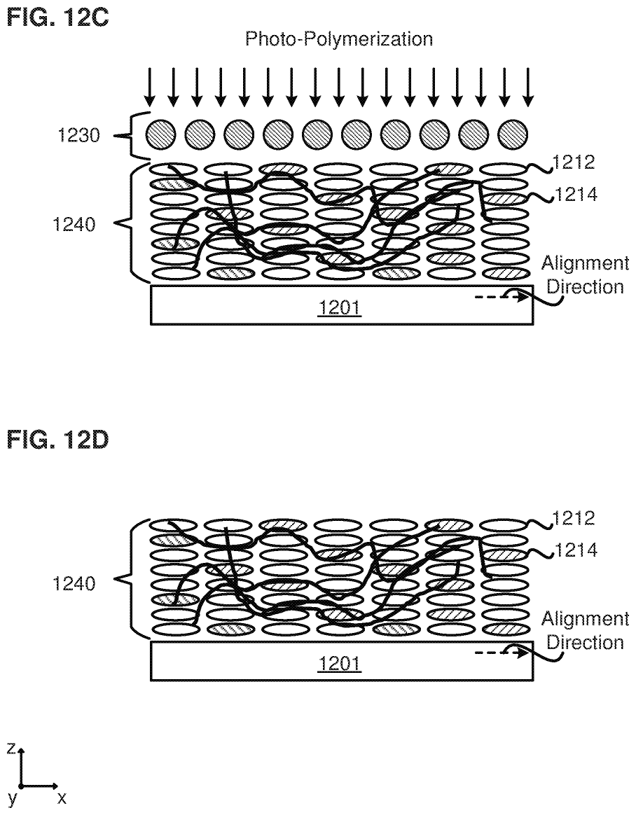

FIGS. 12A, 12B, 12C, and 12D illustrate a manufacturing process in which a temporary layer of particles is used on top of an RM guest-host polarizer material in order to obtain the desired molecular configuration of the RM guest-host polarizer device as depicted in FIG. 5.

With reference to FIG. 12A, a mixture 1260 of an RM guest-host polarizer material 1210 and particles 1232 is deposited onto a deposition substrate 1201 via a deposition process, such as a spin coating process, a slot-die coating process, a dip coating process, ink-jet printing process, etc. The RM guest-host polarizer material 1210 may include host polarizer molecules 1212 and guest polarizer molecules 1214. The particles 1232 may be nano-sized particles and/or micron-sized particles. The particles 1232 may be polymer molecules, surfactants, other chemicals or a mixture of additives. The particles 1232 may be rod shaped and/or spherical shaped.

With reference to FIG. 12B, the mixture 1260 of the RM guest host polarizer material 1210 and particles 1232 separate so that a temporary particulate layer 1230 forms on top of the RM guest host polarizer material 1210. The deposition substrate 1201 may correspond to any of the deposition substrates 601A through 601F described previously. The deposition substrate 1201 causes the molecules of the RM guest-host polarizer material 1210 to adopt planar alignment in a predefined direction at the substrate-side interface 1296. The temporary particulate layer 1230 induces substantially planar alignment of RM guest-host polarizer molecules at the particulate interface 1294 (e.g., non-substrate-side interface).

With reference to FIG. 12C, while the temporary particulate layer 1230 is in contact with RM guest-host polarizer material 1210, the RM guest-host polarizer material 1210 is polymerized to form a polymerized RM guest-host material 1240. The polymerization may be a photo-polymerization process (as previously described). In another implementation, the polymerization may be a thermal polymerization process.

With reference to FIG. 12D, the temporary particulate layer 1230 is removed yielding a polymerized RM guest-host polarizer device as depicted in FIG. 5.

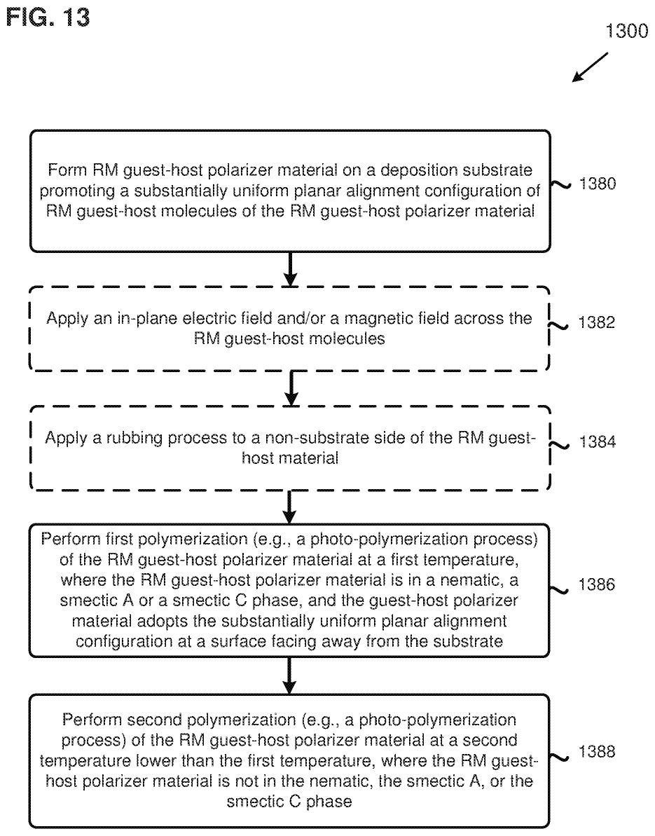

FIG. 13 illustrates a flowchart of a method of fabricating an RM guest-host polarizer device, in accordance with an example implementation of the present disclosure.

In the present implementation, the flowchart 1300 includes actions 1380, 1382, 1384, 1386 and 1388.

As shown in FIG. 13, action 1380 includes forming an RM guest-host polarizer material on a deposition substrate that promotes a substantially uniform planar alignment configuration of RM guest-host molecules of the RM guest-host polarizer material.

Action 1382 includes applying an in-plane electric field and/or a magnetic field across the RM guest-host molecules. For example, the deposition substrates 601E in FIG. 6E and 601F in FIG. 6F may be used to apply an in-plane electric field and/or a magnetic field is applied across the RM guest-host molecules.

Action 1384 includes applying a rubbing process to a non-substrate side of the RM guest-host material.

Action 1386 includes performing a first polymerization (e.g., a photo-polymerization process) of the RM guest-host polarizer material at a first temperature, where the RM guest-host polarizer material is in a nematic, a smectic A or a smectic C phase, and the guest-host polarizer material adopts the substantially uniform planar alignment configuration at a surface facing away from the substrate.

Action 1388 includes performing a second polymerization (e.g., a photo-polymerization process) of the RM guest-host polarizer material at a second temperature lower than the first temperature, where the RM guest-host polarizer material is not in the nematic, the smectic A, or the smectic C phase.

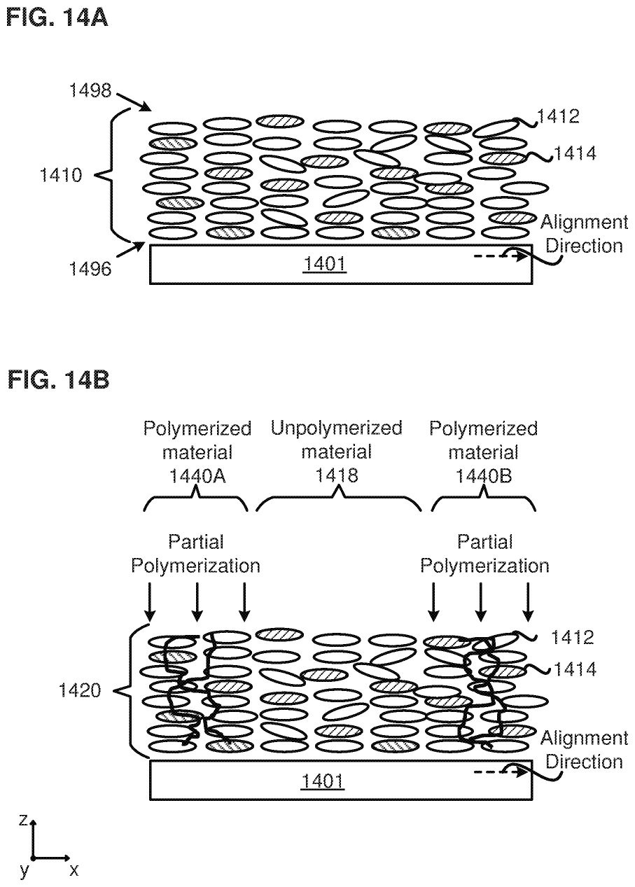

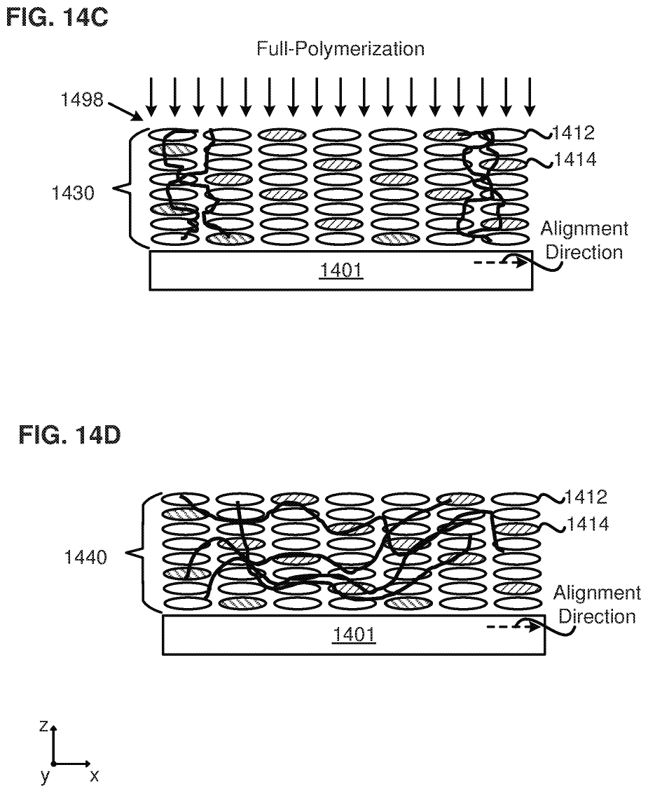

It should be noted that actions 1380 through 1388 may be used during the manufacturing processes described with reference to FIGS. 14A-14D, 15A-15D, 16A-16D, 17A-17D, 18A-18D, and 19A-19D below. In some implementations, actions 1382 and 1384 may be optional.

FIGS. 14A, 14B, 14C, and 14D illustrate a manufacturing process that uses a patterned polymerization procedure of an RM guest-host polarizer material in order to obtain the desired molecular configuration of the RM guest-host polarizer device as depicted in FIG. 5.

With reference to FIG. 14A, an RM guest-host polarizer material 1410 is deposited onto a deposition substrate 1401 via a deposition process, such as a spin coating process, a slot-die coating process, a dip coating process etc.

The deposition substrate 1401 may correspond to any of the deposition substrates 601A through 601F described previously. The deposition substrate 1401 causes the molecules of the RM guest-host polarizer material 1410 to adopt planar alignment in a predefined direction at the substrate-side interface 1496.

The RM guest-host polarizer material 1410 is at a temperature that forms a nematic LC phase, smectic A LC phase or smectic C LC phase. At the air interface 1498 (e.g., the non-substrate-side interface) the RM guest-host polarizer molecules align substantially planar into a partially polymerized RM guest-host polarizer structure 1420 due to the RM guest-host polarizer molecules being in a nematic LC phase, smectic A LC phase or smectic C LC phase.

With reference to FIG. 14B, a patterned polymerization action is performed on the RM guest-host polarizer material 1410 while the RM guest-host polarizer material is in a nematic LC phase, smectic A LC phase or smectic C LC phase to produce a partially polymerized RM guest-host polarizer structure 1420. The patterned polymerization may be performed using a standard photolithographic process using a photomask. The polymerized material 1440A and 1440B may form walls that extend from the top to the bottom of the RM guest-host polarizer material 1420. The walls may form a 1-dimensional pattern (walls extend in 1 direction only) or a 2-dimensional pattern (walls extend in 2 directions, for example, a chequerboard pattern). The width (in the x-direction) of the polymerized material (i.e. walls) may be the same, less than or greater than the width the unpolymerized material 1418.

With reference to FIG. 14C, the partially polymerized RM guest-host polarizer structure 1430 is cooled into a smectic state that is not a smectic A or smectic C phase. The unpolymerized RM guest-host polarizer molecules in the unpolymerized material 1418 do not adopt a vertically aligned state that air interface 1498 because of the presence of the polymer walls. The partially polymerized RM guest-host polarizer structure 1430 is then fully polymerized using a photo-polymerization process (as previously described) or a thermal polymerization process.

With reference to FIG. 14D, after the polymerization process, the RM guest-host polarizer layer 1440 is fully polymerized yielding a polymerized RM guest-host polarizer device as depicted in FIG. 5.

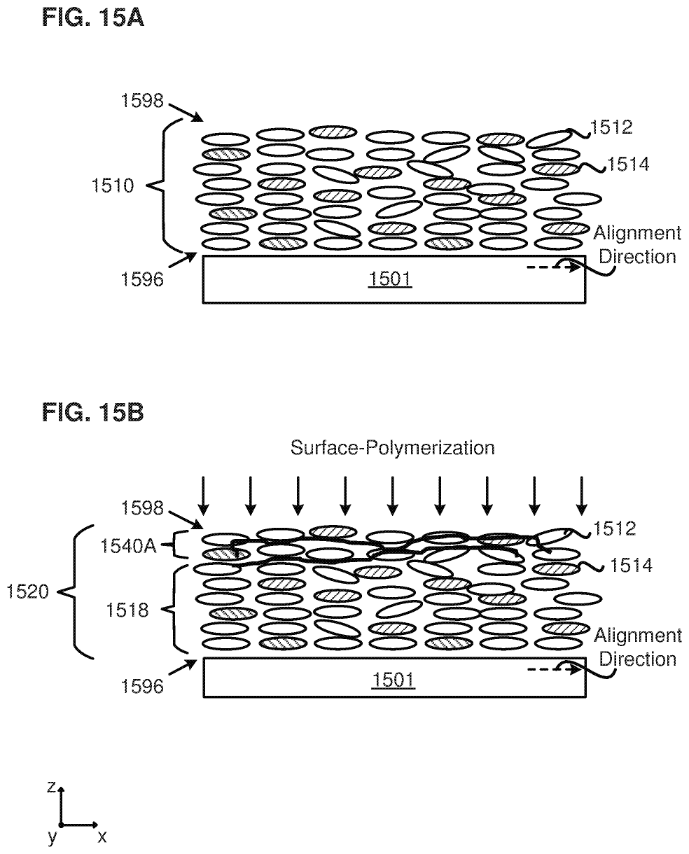

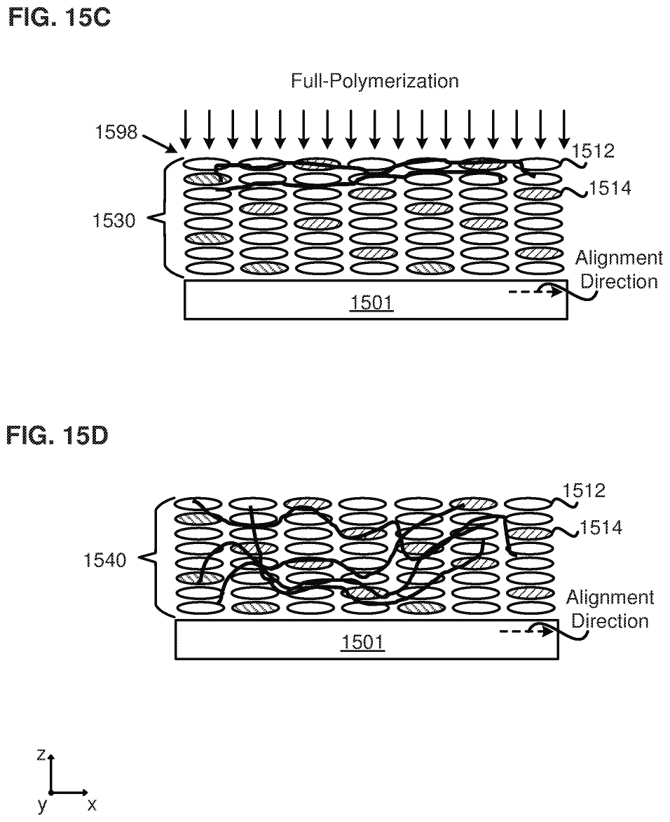

FIGS. 15A, 15B, 15C, and 15D illustrate a manufacturing process that uses a surface polymerization procedure of an RM guest-host polarizer material in order to obtain the desired molecular configuration of the RM guest-host polarizer device as depicted in FIG. 5.

With reference to FIG. 15A, an RM guest-host polarizer material 1510 is deposited onto a deposition substrate 1501 via a deposition process, such as a spin coating process, a slot-die coating process, a dip coating process, ink-jet printing process, etc.

The deposition substrate 1501 may correspond to any of the deposition substrates 601A through 601F described previously. The deposition substrate 1501 causes the molecules of the RM guest-host polarizer material 1510 to adopt planar alignment in a predefined direction at the substrate-side interface 1596.

The RM guest-host polarizer material 1510 is at a temperature that forms a nematic LC phase, smectic A LC phase or smectic C LC phase. At the air interface 1598 (e.g., the non-substrate-side interface) the RM guest-host polarizer molecules align planar due to the RM being in a nematic LC phase, smectic A LC phase or smectic C LC phase into a partially polymerized RM guest-host polarizer structure 1520.

With reference to FIG. 15B, a surface polymerization action is performed on the RM guest-host polarizer material 1510 while the RM guest-host polarizer material is in a nematic LC phase, smectic A LC phase or smectic C LC phase to produce a partially polymerized RM guest-host polarizer structure 1520. The surface polymerized material 1540A forms a thin layer that resides next to the air interface 1598 and on top of the unpolymerized bulk 1518 of the RM guest-host polarizer material 1520. The surface polymerization may be performed by exposure to radiation that is strongly absorbed by the surface region. The surface polymerization may be performed via a photo-polymerization process using UVA and/or UVB and/or UVC wavelengths. A short wavelength band pass filter may be used for the surface photo-polymerization step or a notch wavelength filter may be used for the surface photo-polymerization step.

With reference to FIG. 15C, the partially polymerized RM guest-host polarizer structure 1530 is cooled into a smectic state that is not a smectic A or smectic C phase. The partially polymerized RM guest-host polarizer structure 1530 is then fully polymerized using a photo-polymerization process (as previously described) or a thermal polymerization process.

With reference to FIG. 15D, after the polymerization process, the RM guest-host polarizer layer 1540 is fully polymerized yielding a polymerized RM guest-host polarizer device as depicted in FIG. 5.

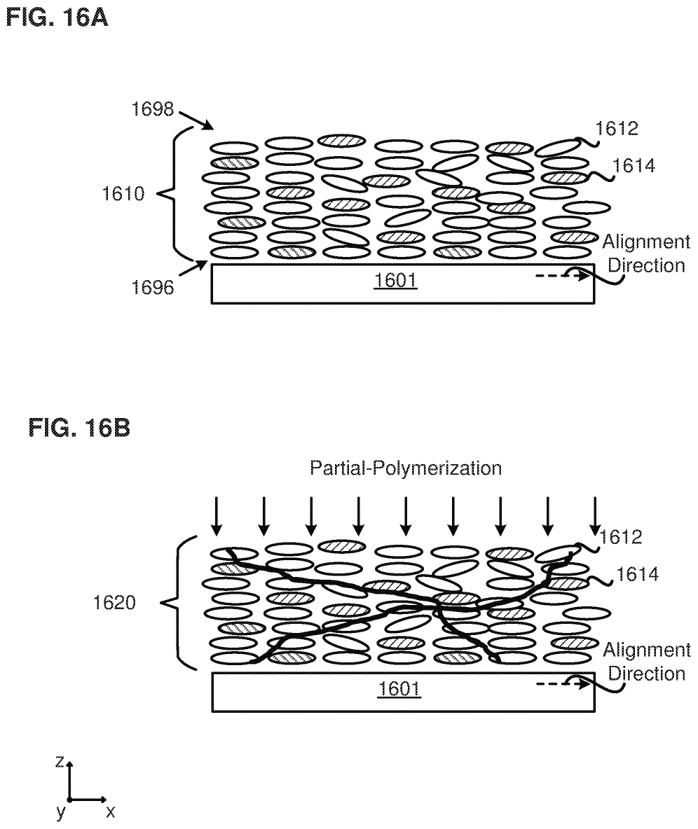

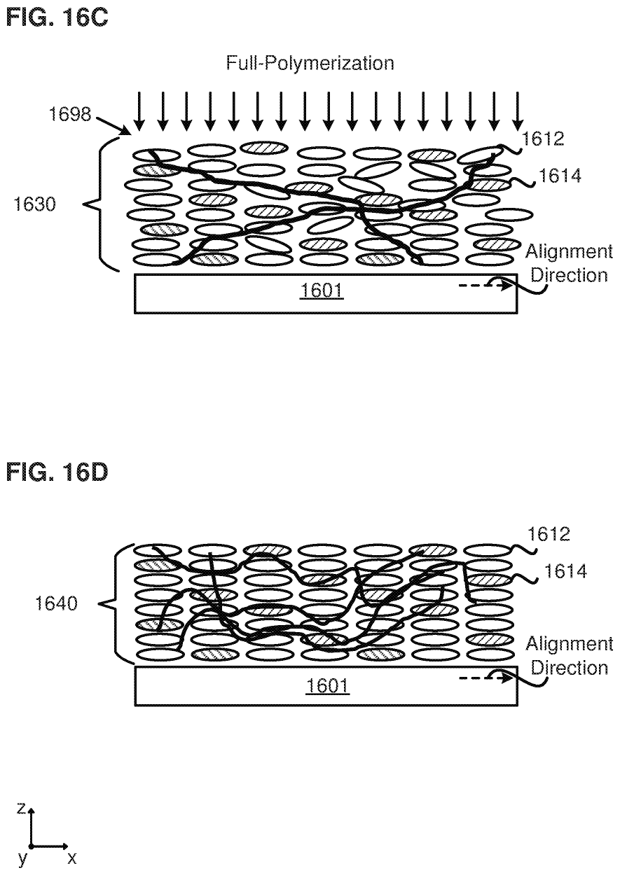

FIGS. 16A, 16B, 16C, and 16D illustrate a manufacturing process that uses a partial polymerization procedure of an RM guest-host polarizer material in order to obtain the desired molecular configuration of the RM guest-host polarizer device as depicted in FIG. 5.

With reference to FIG. 16A, an RM guest-host polarizer material 1610 is deposited onto a deposition substrate 1601 via a deposition process, such as a spin coating process, a slot-die coating process, a dip coating process, ink-jet printing process, etc. The deposition substrate 1601 may correspond to any of the deposition substrates 601A through 601F described previously. The deposition substrate 1601 causes the molecules of the RM guest-host polarizer material 1610 to adopt planar alignment in a predefined direction at the substrate-side interface 1696.

The RM guest-host polarizer material 1610 is at a temperature that forms a nematic LC phase, smectic A LC phase or smectic C LC phase. At the air interface 1698, the RM guest-host polarizer molecules align substantially planar into a partially polymerized RM guest-host polarizer structure 1620 because the RM is in a nematic LC phase, smectic A LC phase or smectic C LC phase.

With reference to FIG. 16B, a partial polymerization action is performed on the RM guest-host polarizer material 1610 while the RM guest-host polarizer material is in a nematic LC phase, smectic A LC phase or smectic C LC phase to produce a partially polymerized RM guest-host polarizer structure 1620. The partial polymerization may be performed via a photo-polymerization process using UVA and/or UVB and/or UVC wavelengths. A short wavelength band pass filter may be used for the surface photo-polymerization step or a notch wavelength filter may be used for the surface photo-polymerization step.

With reference to FIG. 16C, the partially polymerized RM guest-host polarizer structure 1630 is cooled into a smectic state that is not a smectic A or smectic C phase. The RM guest-host polarizer film 1630 is then fully polymerized using a photo-polymerization process (as previously described) or a thermal polymerization process.

With reference to FIG. 16D, after the polymerization process, the RM guest-host polarizer layer 1640 is fully polymerized yielding a polymerized RM guest-host polarizer device as depicted in FIG. 5.

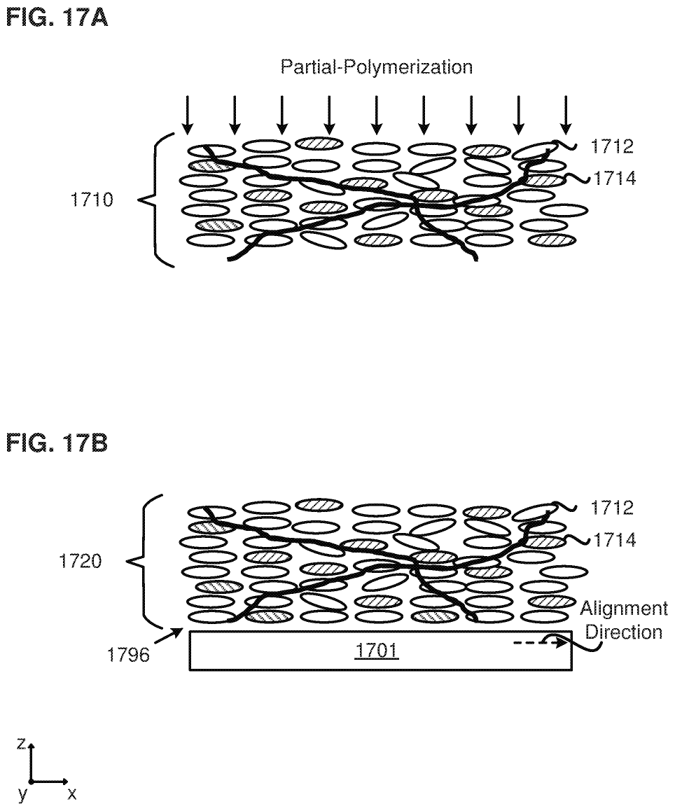

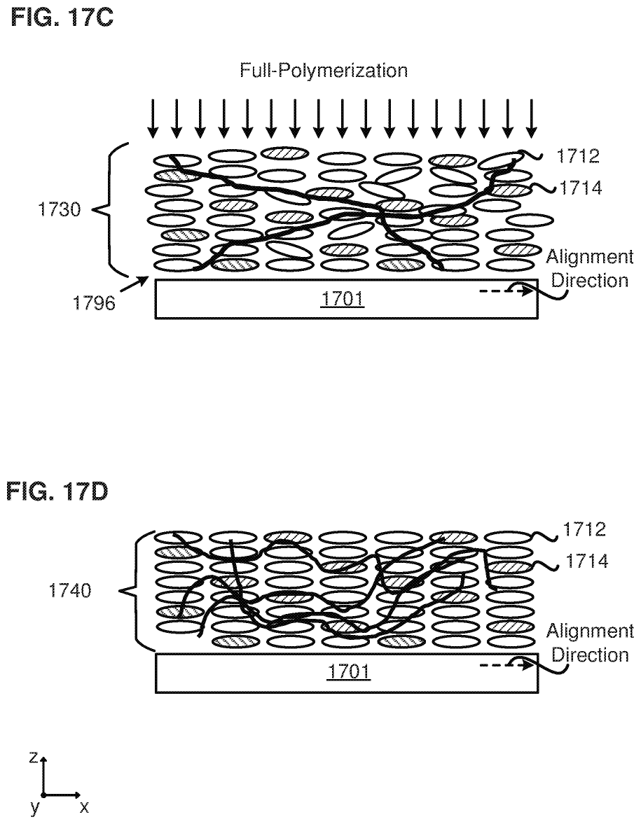

FIGS. 17A, 17B, 17C, and 17D illustrate another manufacturing process that uses a partial polymerization procedure of an RM guest-host polarizer material in order to obtain the desired molecular configuration of the RM guest-host polarizer device as depicted in FIG. 5.

With reference to FIG. 17A, an RM guest-host polarizer material 1710 is partially polymerized using a photo-polymerization process (as previously described) or a thermal polymerization process to produce a partially polymerized RM guest-host polarizer structure 1720.

With reference to FIG. 17B, the partially polymerized RM guest-host polarizer structure 1720 is deposited onto a deposition substrate 1701 via a deposition process, such as a spin coating process, a slot-die coating process, a dip coating process, ink-jet printing process, etc.

The deposition substrate 1701 may correspond to any of the deposition substrates 601A through 601F described previously. The deposition substrate 1701 causes the molecules of the partially polymerized RM guest-host polarizer material 1720 to adopt planar alignment in a predefined direction at the substrate-side interface 1796.

With reference to FIG. 17C, the partially polymerized RM guest-host polarizer structure 1730 is cooled into a smectic state that is not a smectic A or smectic C phase. The partially polymerized RM guest-host polarizer structure 1730 is then fully polymerized using a photo-polymerization process (as previously described) or a thermal polymerization process.

With reference to FIG. 17D, after the polymerization process, the RM guest-host polarizer layer 1740 is fully polymerized yielding a polymerized RM guest-host polarizer device as depicted in FIG. 5.

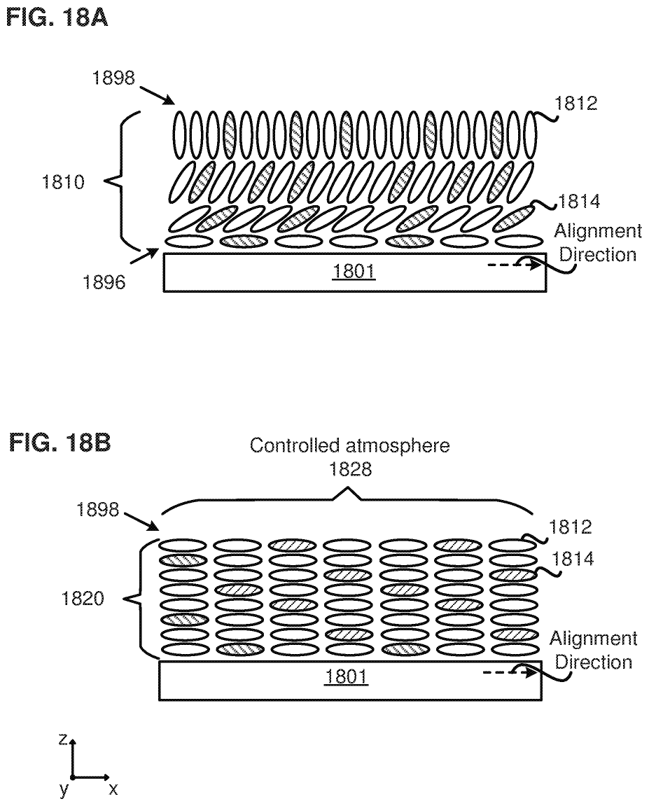

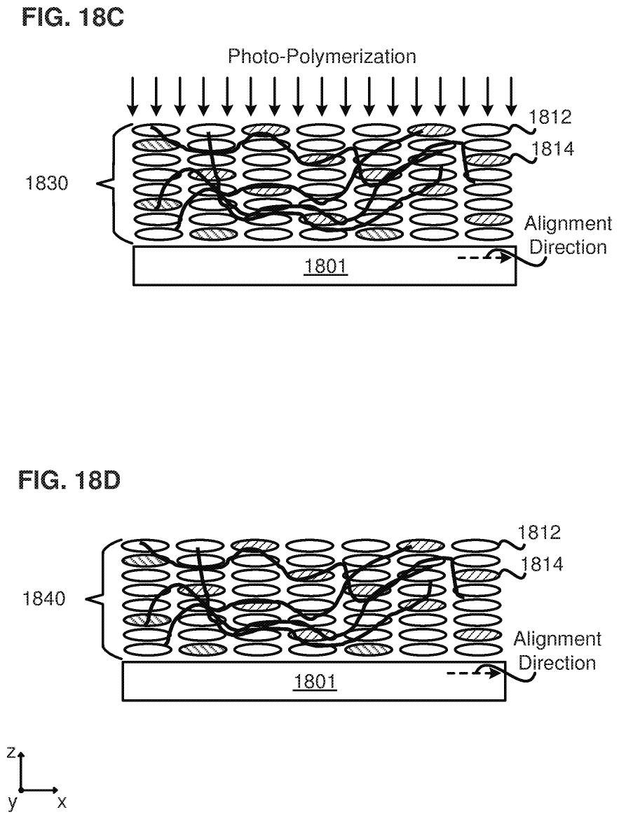

FIGS. 18A, 18B, 18C, and 18D illustrate a manufacturing process that uses a controlled atmosphere above an RM guest-host polarizer material in order to obtain the desired molecular configuration of the RM guest-host polarizer device as depicted in FIG. 5.

With reference to FIG. 18A, an RM guest-host polarizer material 1810 is deposited onto a deposition substrate 1801 via a deposition process, such as a spin coating process, a slot-die coating process, a dip coating process, ink-jet printing process, etc.

The deposition substrate 1801 may correspond to any of the deposition substrates 601A through 601F described previously. The deposition substrate 1801 causes the molecules of the RM guest-host polarizer material 1810 to adopt planar alignment in a predefined direction at the substrate-side interface 1896. At the air interface 1898 (e.g., non-substrate-side interface) the molecules of the RM guest-host polarizer material 1810 align vertically, causing a splayed molecular structure as shown in FIG. 4.

With reference to FIG. 18B, the non-substrate side of the RM guest-host polarizer s structure 1820 is exposed to a controlled atmosphere 1828 to induce planar alignment of the host polarizer molecules 1812 and guest polarizer molecules 1814 at the controlled atmosphere interface 1898. The controlled atmosphere 1828 may be a vacuum. The controlled atmosphere 1828 may comprise a gas or mixture of gases. The gaseous atmosphere may be above or below atmospheric pressure. The gaseous atmosphere may be the same as atmospheric pressure. The gaseous atmosphere may comprise an inert gas such as nitrogen and/or a noble gas or gases. The controlled atmosphere 1828 causes the molecules of the RM guest-host polarizer material 1810 to adopt planar alignment in a predefined direction at the non-substrate side interface 1898.

With reference to FIG. 18C, the RM guest-host polarizer structure 1830 is polymerized using a photo-polymerization process (as previously described) or a thermal polymerization process.

With reference to FIG. 18D, after the polymerization process, the RM guest-host polarizer layer 1840 is fully polymerized yielding a polymerized RM guest-host polarizer device as depicted in FIG. 5.

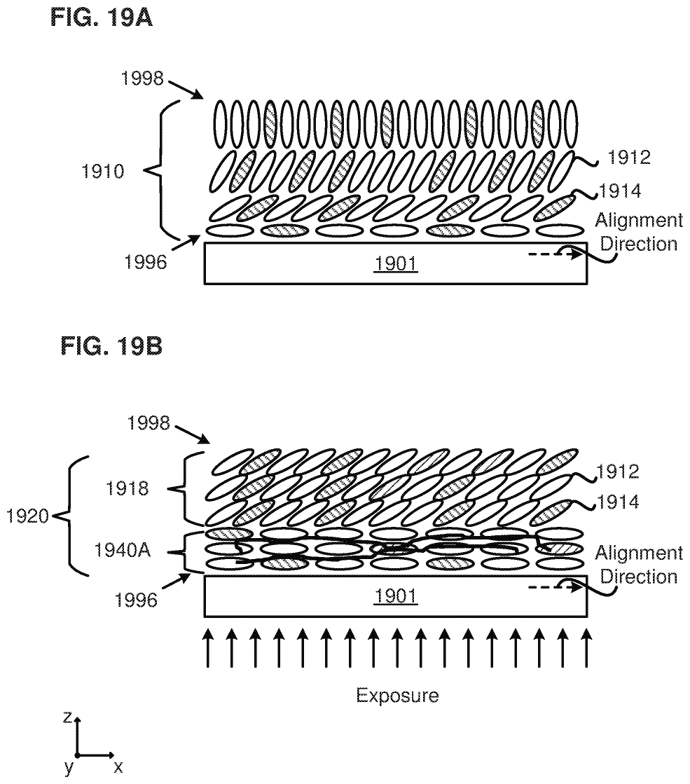

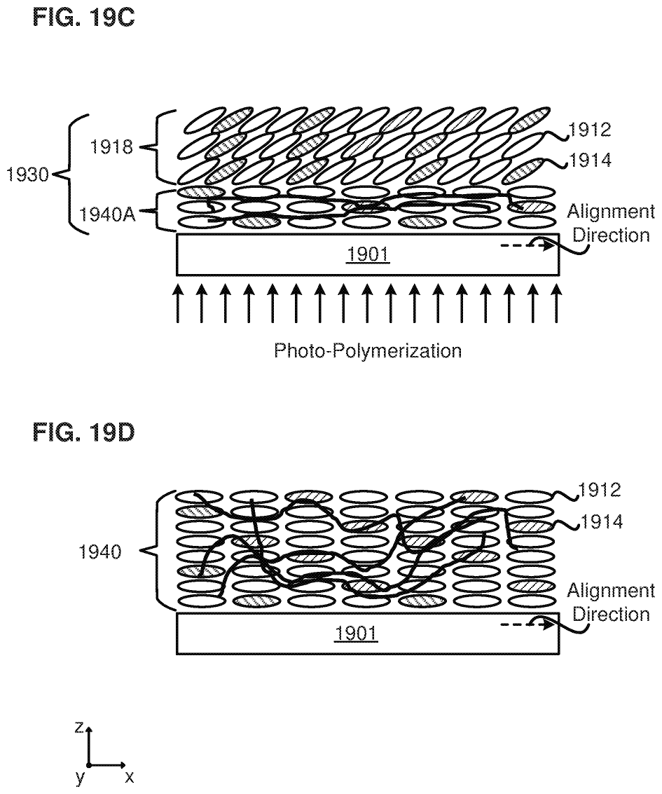

FIGS. 19A, 19B, 19C, and 19D illustrate a manufacturing process that uses a photo-polymerization exposure procedure in which an RM guest-host polarizer material is photo-polymerized via an exposure from the substrate side in order to obtain the desired molecular configuration of the RM guest-host polarizer device as depicted in FIG. 5.

With reference to FIG. 19A, an RM guest-host polarizer material 1910 is deposited onto a deposition substrate 1901 via a deposition process, such as a spin coating process, a slot-die coating process, a dip coating process, ink-jet printing process, etc. The deposition substrate 1901 may correspond to any of the deposition substrates 601A through 601F described previously. The deposition substrate 1901 causes the molecules of the RM guest-host polarizer material 1910 to adopt planar alignment in a predefined direction at the substrate-side interface 1996. At the air interface 1998 (e.g., non-substrate-side interface) the molecules of the RM guest-host polarizer material 1910 align vertically, causing a splayed molecular structure as shown in FIG. 4.

With reference to FIG. 19B, the RM guest-host polarizer material 1910 is photo-polymerized via an exposure from the substrate side, thus the RM guest-host polarizer material is polymerized at the substrate-side interface 1996 (e.g., the substrate-side interface) before the air interface 1998. As the polymerization network in the RM guest-host polarizer material 1920 grows from the substrate-side in the positive z-direction (e.g., towards the air interface 1998), the RM guest-host polarizer material 1920 adopts planar alignment. The polymerization may be performed by a photo-polymerization process using UVA and/or UVB and/or UVC wavelengths. A short wavelength band pass filter may be used for the surface photo-polymerization step or a notch wavelength filter may be used for the surface photo-polymerization step. The deposition substrate 1901 is selected that is at least partially transmissive to the exposure radiation.

With reference to FIG. 19C, the partially polymerized RM guest-host polarizer structure 1930 is fully polymerized using a photo-polymerization process (as previously described) via exposure through the substrate 1901 or a thermal polymerization process.

With reference to FIG. 19D, after the polymerization process, the RM guest-host polarizer layer 1940 is fully polymerized yielding a polymerized RM guest-host polarizer device as depicted in FIG. 5.

With reference to any of the preceding implementations, the surface of the RM guest-host polarizer layer may be rubbed during the polymerization process in order to obtain the desired molecular configuration of the RM guest-host polarizer device as depicted in FIG. 5.

With reference to any of the preceding implementations, the RM guest-host polarizer material may be deposited via a slot-die coating or a doctor blade coating method or another method that causes a shearing of the deposited material. A slot-die coating method and a doctor blade coating method cause a shear of the deposition material. This shearing action may be used to obtain substantially uniform planar alignment of the guest-host polarizer molecules as depicted in FIG. 5. Polymerization of the RM guest-host polarizer material may be performed during and/or after a deposition process.

With reference to any of the preceding implementations, the final RM guest-host polarizer layer may be comprised of multiple RM guest-host polarizer layers that are deposited and polymerized in a sequential fashion. An example of such a fabrication process now follows. A first layer of RM guest-host polarizer material may be deposited on a substrate and polymerized. After polymerization, a rubbing process and/or a photoalignment process may be performed on the exposed surface (non-substrate surface) of the first layer of RM guest-host polarizer material. The purpose of the rubbing process and/or photoalignment process is to provide an alignment surface for a second layer of RM guest-host polarizer material. Next, a second layer of RM guest-host polarizer material may be deposited upon the first layer RM guest-host polarizer material. The second layer of RM guest-host polarizer material is then polymerized. In general, the RM guest-host polarizer layer may be fabricated via multiple iterations of deposition, alignment stage (if applicable) followed by polymerization. The use of multiple RM guest-host polarizer layers may be used to obtain substantially uniform planar alignment of the guest-host polarizer molecules as depicted in FIG. 5.

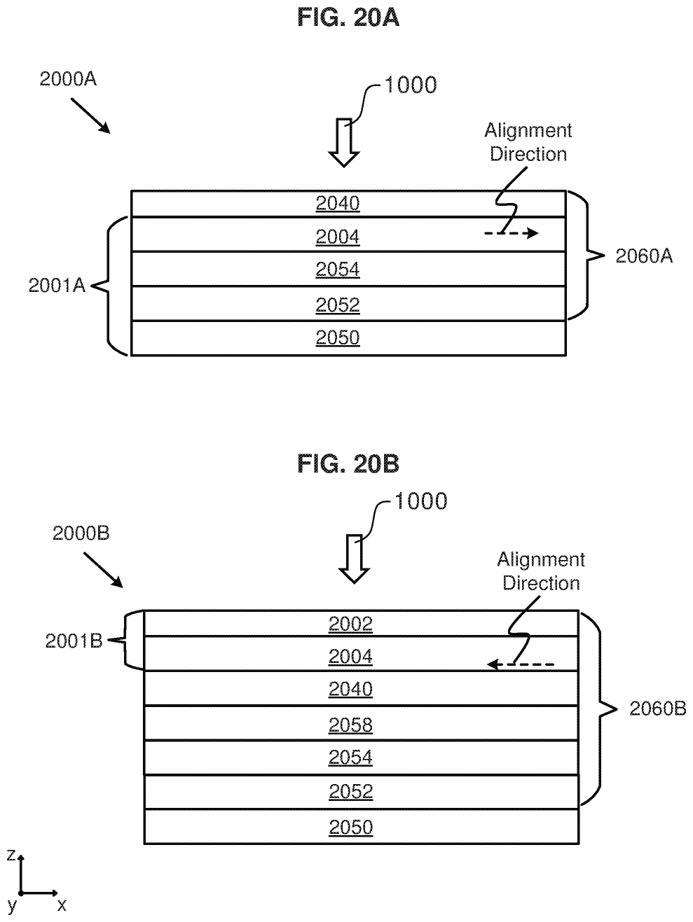

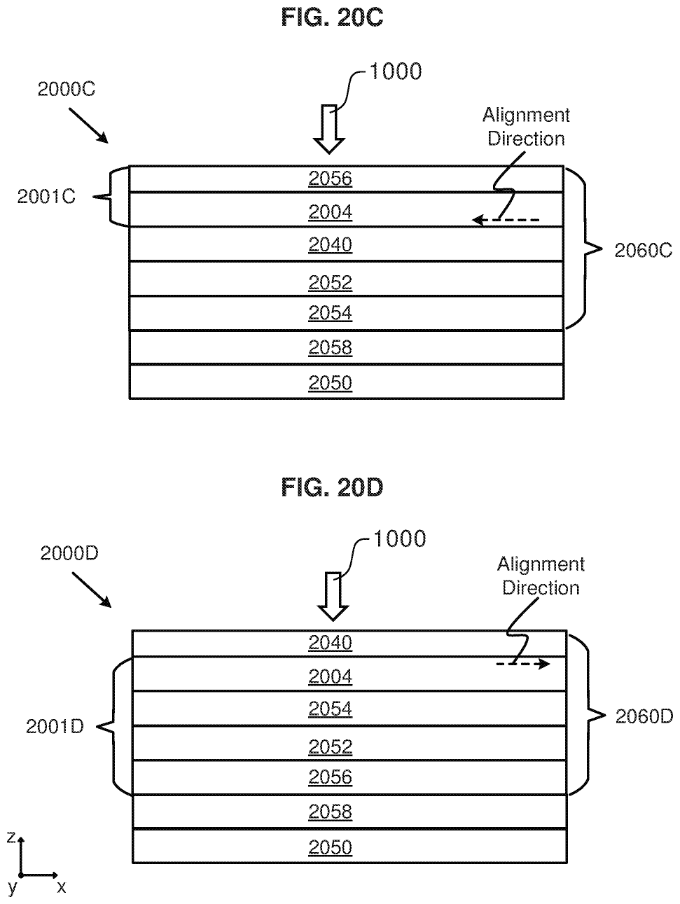

FIG. 20A is a schematic diagram of a display structure having an OLED display with a circular polarizer, in accordance with an example implementation of the present disclosure. From the viewing direction 1000, the display structure 2000A includes a guest-host polarizer layer 2040, a guest-host polarizer alignment layer 2004 (substantially corresponding to the alignment layer 604 in FIG. 6), a Quarter Wave Plate (QWP) retarder (λ/4) 2054, a QWP retarder alignment layer 2052, and an OLED display 2050.

In the implementation of FIG. 20A, the guest-host polarizer layer 2040 may substantially corresponding to the guest-host polarizer layer 540 in FIG. 5. The guest-host polarizer alignment layer 2004 may substantially correspond to the alignment layer 604 in FIG. 6. The QWP retarder 2054, QWP retarder alignment layer 2052, and OLED display 2050 may together substantially correspond to the substrate 602 in FIG. 6. In other words, the guest-host polarizer alignment layer 2004, QWP retarder 2054, QWP retarder alignment layer 2052, and OLED display 2050 may be together referred to as a deposition substrate 2001A, which may substantially correspond to the deposition substrate 501 in FIG. 5. It should be noted that each of the deposition substrates 601A, 601B, 601C, 601D, 601E and 601F respectively shown and described in FIGS. 6A, 6B, 6C, 6D, 6E and 6F may correspond to the deposition substrate 2001A referenced in FIG. 20A.

In the present implementation the guest-host polarizer layer 2040, guest-host polarizer alignment layer 2004, QWP retarder 2054, QWP retarder alignment layer 2052, and OLED display 2050 together may be together referred to as a guest-host polarizer device, which may substantially correspond to the guest-host smectic phase polarizer device 500 in FIG. 5.

As shown in FIG. 20A, the guest-host polarizer layer 2040, guest-host polarizer alignment layer 2004, QWP retarder 2054, and QWP retarder alignment layer 2052 together form a circular polarizer 2060A. The circular polarizer 2060A reduces reflections of ambient light from the internal structure of the OLED display 2050 to improve perceived contrast ratio. The transmission axis of the guest-host polarizer layer 2040 is arranged by its respective alignment layer to be at 45° to the optical axis of the QWP retarder 2054. The QWP retarder 2054 may be a polymerized RM layer that has an optical axis that is orientated before polymerization by its respective alignment layer (e.g., the QWP retarder alignment layer 2052).

The OLED display 2050 has many layers (substrate, electrodes, hole transport layer, electron transport layer, encapsulation layer etc.) that have been omitted for clarity. An encapsulation layer (not explicitly shown) may be deposited on the OLED display 2050 before the circular polarizer 2060A is deposited but other layers may be deposited between the encapsulation layer and the circular polarizer 2060A, such as electrodes for a touch screen (not explicitly shown). In one implementation, a hard coat (not explicitly shown) may be deposited on the viewing direction 1000 of the guest-host polarizer layer 2040.

In the implementation of FIG. 20A, among other advantages, depositing the circular polarizer 2060A directly upon the OLED display 2050 reduces the overall thickness of the display structure 2000A. The reduced thickness is beneficial for weight reduction and attractive aesthetics. For example, the reduced thickness is essential for realizing a curved display or a flexible display.

FIG. 20B is a schematic diagram of a display structure having an OLED display with a circular polarizer, in accordance with another example implementation of the present disclosure. From the viewing direction 1000, the display structure 2000B includes a substrate 2002, a guest-host polarizer alignment layer 2004, a guest-host polarizer layer 2040, an adhesion layer 2058, a QWP retarder 2054, a QWP retarder alignment layer 2052, and an OLED display 2050.

In the implementation of FIG. 20B, the guest-host polarizer layer 2040 may substantially correspond to the guest-host polarizer layer 540 in FIG. 5. The guest-host polarizer alignment layer 2004 may substantially correspond to the alignment layer 604 in FIG. 6. The substrate 2002 may substantially correspond to the substrate 602 in FIG. 6. In other words, the guest-host polarizer alignment layer 2004 and substrate 2002 may be together referred to as a deposition substrate 2001B, which may substantially correspond to the deposition substrate 501 in FIG. 5. It should be noted that each of the deposition substrates 601A, 601B, 601C, 601D, 601E and 601F respectively shown and described in FIGS. 6A, 6B, 6C, 6D, 6E and 6F may correspond to the deposition substrate 2001B referenced in FIG. 20B.

As shown in FIG. 20B, the guest-host polarizer layer 2040, guest-host polarizer alignment layer 2004, and substrate 2002 form a guest-host polarizer device, that is adhered to the QWP retarder 2054 through the adhesion layer 2058 (e.g., an optical adhesive).

As shown in FIG. 20B, the substrate 2002, guest-host polarizer alignment layer 2004, guest-host polarizer layer 2040, adhesion layer 2058, QWP retarder 2054, and QWP retarder alignment layer 2052 together form a circular polarizer 2060B. The circular polarizer 2060B reduces reflections of ambient light from the internal structure of the OLED display 2050 to improve perceived contrast ratio. The transmission axis of the guest-host polarizer layer 2040 is arranged by its respective alignment layer to be at 45° to the optical axis of the QWP retarder 2054. The QWP retarder 2054 may be a polymerized RM layer that has an optical axis that is orientated before polymerization by its respective alignment layer (e.g., the QWP retarder alignment layer 2052).

The OLED display 2050 has many layers (substrate, electrodes, hole transport layer, electron transport layer, encapsulation layer etc.) that have been omitted for clarity. An encapsulation layer (not explicitly shown) may be deposited on the OLED display 2050 before the circular polarizer 2060B is deposited but other layers may be deposited between the encapsulation layer and the circular polarizer 2060B, such as electrodes for a touch screen (not explicitly shown). The circular polarizer 2060B may be adhered to the OLED display 2050, for example, using an optical adhesive.

In the implementation of FIG. 20B, among other advantages, using the adhesion layer 2058 to adhere the guest-host polarizer device to the QWP retarder 2054 may ease the complexity of manufacturing.

FIG. 20C is a schematic diagram of a display structure having an OLED display with a circular polarizer, in accordance with another example implementation of the present disclosure. From the viewing direction 1000, the display structure 2000C includes a circular polarizer substrate 2056, a guest-host polarizer alignment layer 2004, a guest-host polarizer layer 2040, a QWP retarder alignment layer 2052, a QWP retarder 2054, an adhesion layer 2058, and an OLED display 2050. In one implementation, guest-host polarizer alignment layer 2004, guest-host polarizer layer 2040, QWP retarder alignment layer 2052, and QWP retarder 2054 are deposited sequentially on the substrate 2056. The structure is then adhered to the OLED display 2050 using the adhesion layer 2058, with the QWP retarder 2054 facing the OLED display 2050.

In the implementation of FIG. 20C, the guest-host polarizer layer 2040 may substantially correspond to the guest-host polarizer layer 540 in FIG. 5. The guest-host polarizer alignment layer 2004 may substantially correspond to the alignment layer 604 in FIG. 6. The circular polarizer substrate 2056 may substantially correspond to the substrate 602 in FIG. 6. In other words, the guest-host polarizer alignment layer 2004 and circular polarizer substrate 2056 may be together referred to as a deposition substrate 2001C, which may substantially correspond to the deposition substrate 501 in FIG. 5. It should be noted that each of the deposition substrates 601A, 601B, 601C, 601D, 601E and 601F respectively shown and described in FIGS. 6A, 6B, 6C, 6D, 6E and 6F may correspond to the deposition substrate 2001C referenced in FIG. 20C.

As shown in FIG. 20C, the guest-host polarizer layer 2040, guest-host polarizer alignment layer 2004, and circular polarizer substrate 2056 form a guest-host polarizer device.

As shown in FIG. 20C, the circular polarizer substrate 2056, guest-host polarizer alignment layer 2004, guest-host polarizer layer 2040, QWP retarder alignment layer 2052, and QWP retarder 2054 together form a circular polarizer 2060C. The circular polarizer 2060C reduces reflections of ambient light from the internal structure of the OLED display 2050 to improve perceived contrast ratio. The transmission axis of the guest-host polarizer layer 2040 is arranged by the guest-host polarizer alignment layer 2004 to be at 45° to the optical axis of the QWP retarder 2054. The QWP retarder 2054 may be a polymerized RM layer that has an optical axis that is orientated before polymerization by its respective alignment layer (e.g., the QWP retarder alignment layer 2052).

The OLED display 2050 has many layers (substrate, electrodes, hole transport layer, electron transport layer, encapsulation layer etc.) that have been omitted for clarity. An encapsulation layer (not explicitly shown) may be deposited on the OLED display 2050 before the circular polarizer 2060C is deposited but other layers may be deposited between the encapsulation layer and the circular polarizer 2060C, such as electrodes for a touch screen (not explicitly shown). The circular polarizer 2060C is adhered to the OLED display 2050, for example, using the adhesion layer 2058 (e.g., an optical adhesive).

In the implementation of FIG. 20C, among other advantages, using the adhesion layer 2058 to adhere the circular polarizer 2060C to the OLED display 2050 may ease the complexity of manufacturing.

FIG. 20D is a schematic diagram of a display structure having an OLED display with a circular polarizer, in accordance with another example implementation of the present disclosure. From the viewing direction 1000, the display structure 2000D includes a guest-host polarizer layer 2040, a guest-host polarizer alignment layer 2004, a QWP retarder 2054, a QWP retarder alignment layer 2052, a circular polarizer substrate 2056, an adhesion layer 2058, and an OLED display 2050.

In the implementation of FIG. 20D, the guest-host polarizer layer 2040 may substantially correspond to the guest-host polarizer layer 540 in FIG. 5. The guest-host polarizer alignment layer 2004 may substantially correspond to the alignment layer 604 in FIG. 6. The QWP retarder 2054, QWP retarder alignment layer 2052, and circular polarizer substrate 2056 may substantially correspond to the substrate 602 in FIG. 6. In other words, the guest-host polarizer alignment layer 2004, QWP retarder 2054, QWP retarder alignment layer 2052, and circular polarizer substrate 2056 may be together referred to as a deposition substrate 2001D, which may substantially correspond to the deposition substrate 501 in FIG. 5. It should be noted that each of the deposition substrates 601A, 601B, 601C, 601D, 601E and 601F respectively shown and described in FIGS. 6A, 6B, 6C, 6D, 6E and 6F may correspond to the deposition substrate 2001D referenced in FIG. 20D.

As shown in FIG. 20D, the guest-host polarizer layer 2040, guest-host polarizer alignment layer 2004, QWP retarder 2054, QWP retarder alignment layer 2052, and circular polarizer substrate 2056 together form a circular polarizer 2060D. The circular polarizer 2060D reduces reflections of ambient light from the internal structure of the OLED display 2050 to improve perceived contrast ratio. The transmission axis of the guest-host polarizer layer 2040 is arranged by its respective alignment layer to be at 45° to the optical axis of the QWP retarder 2054. The QWP retarder 2054 may be a polymerized RM layer that has an optical axis that is orientated before polymerization by its respective alignment layer (e.g., the QWP retarder alignment layer 2052).

The OLED display 2050 has many layers (substrate, electrodes, hole transport layer, electron transport layer, encapsulation layer etc.) that have been omitted for clarity. An encapsulation layer (not explicitly shown) may be deposited on the OLED display 2050 before the circular polarizer 2060D is deposited but other layers may be deposited between the encapsulation layer and the circular polarizer 2060D, such as electrodes for a touch screen (not explicitly shown). The circular polarizer 2060D may be attached to the OLED display 2050 through the adhesion layer 2058 (e.g., an optical adhesive). In one implementation, a hard coat (not explicitly shown) may be deposited on the viewing side (1000) of the guest-host polarizer layer 2040.

In the implementation of FIG. 20D, among other advantages, using the adhesion layer 2058 to adhere the circular polarizer 2060D to the OLED display 2050 may ease the complexity of manufacturing.

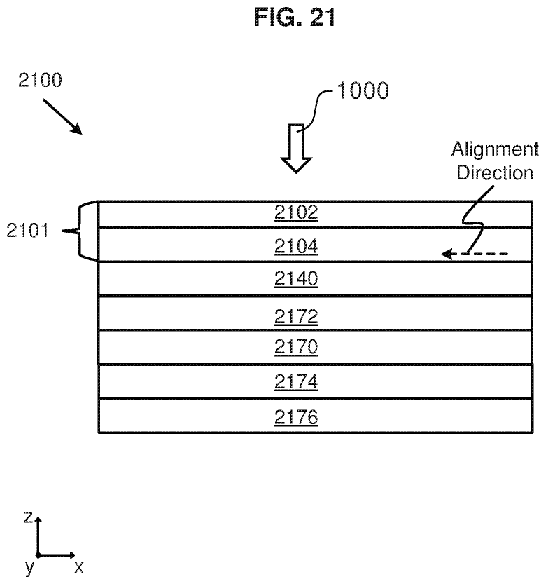

FIG. 21 is a schematic diagram of a display structure having Liquid Crystal Display (LCD) with an in-cell polarizer, in accordance with an example implementation of the present disclosure. From the viewing direction 1000, the display structure 2100 includes a first substrate 2102, a guest-host polarizer alignment layer 2104 a guest-host polarizer layer 2140, a first LC alignment layer 2172, an LC layer 2170, a second LC alignment layer 2174, and a second substrate 2176. The polarizer is called “in-cell” because it is located between the first substrate 2102 and second substrate 2176 that comprise the liquid crystal cell.

In the implementation of FIG. 21, the guest-host polarizer layer 2140 may substantially correspond to the guest-host polarizer layer 540 in FIG. 5. The guest-host polarizer alignment layer 2104 may substantially correspond to the alignment layer 604 in FIG. 6. The first substrate 2102 may substantially correspond to the substrate 602 in FIG. 6. In other words, the guest-host polarizer alignment layer 2104 and first substrate 2102 may be together referred to as a deposition substrate 2101, which may substantially correspond to the deposition substrate 501 in FIG. 5. As shown in FIG. 21, the guest-host polarizer layer 2140, guest-host polarizer alignment layer 2104, and first substrate 2102 form a guest-host polarizer device, that may correspond to the guest-host smectic phase polarizer device 500 in FIG. 5. It should be noted that each of the deposition substrates 601A, 601B, 601C, 601D, 601E, and 601F respectively shown and described in FIGS. 6A, 6B, 6C, 6D, 6E and 6F may correspond to the deposition substrate 2101 referenced in FIG. 21.

The first substrate 2102 may be a color filter substrate or a thin-film-transistor (TFT) substrate or a combination thereof. The second substrate 2176 may be a color filter substrate or a TFT substrate or a combination thereof. The first substrate 2102 and second substrate 2176 may be on the viewing side of the LCD. Conventional linear polarizers (not shown) or conventional circular polarizers (not shown) or combination thereof may be adhered to the outer surfaces of the first and second substrates. The total added thickness of the guest-host polarizer layer 2140 and the guest-host polarizer alignment layer is the same order of magnitude as the LC layer 2170 thickness. Typically, the total added thickness of the guest-host polarizer layer 2140 and the guest-host polarizer alignment layer 2104 is less than 10 μm and preferably less than 4 μm and further preferably less than 2 μm. The low added thickness of the guest-host polarizer layer 2140 and the guest-host polarizer alignment layer 2104 is required to avoid unwanted parallax issues between neighboring pixels of the display. The in-cell polarizer shown in FIG. 21 may be used to improve contrast ratio.

Implementations of the present disclosure are applicable to many display devices (LCD, OLED etc.) in which high image quality is required for all ambient lighting conditions. Examples of such devices include mobile phones such as smartphones, personal digital assistants (PDAs), tablets, laptop computers, televisions, public information displays etc.

What is claimed is:

1. A method of fabricating a reactive mesogen (RM) guest-host polarizer, the method comprising:
forming an RM guest-host polarizer material on a substrate that promotes a substantially uniform planar alignment configuration of the RM guest-host molecules;
forming a temporary layer on the RM guest-host polarizer material to align RM guest-host molecules of the RM guest-host polarizer material in the substantially uniform planar alignment configuration;
performing polymerization of the RM guest-host polarizer material; and
removing the temporary layer from the RM guest-host polarizer;
wherein the temporary layer includes at least one of:
a temporary fluid layer;
a temporary particulate layer;
a temporary gaseous layer;
a temporary vacuum layer; and
a temporary alignment substrate layer.

2. The method of claim 1, wherein:
the RM guest-host polarizer material is formed on the substrate at a first temperature, the substrate having a first surface energy;
the temporary alignment substrate layer encapsulates the RM guest-host polarizer material, the temporary alignment substrate layer having a second surface energy lower than the first surface energy, the temporary alignment substrate layer also aligns the RM guest-host molecules in the substantially uniform planar alignment configuration.

3. The method of claim 2, wherein the RM guest-host polarizer material is polymerized at a second temperature lower than the first temperature.

4. The method of claim 1, wherein the polymerization of the RM guest-host polarizer material includes a photo-polymerization process that is performed through at least one of the substrate and the temporary layer pertaining to the RM guest-host polarizer material.

5. The method of claim 1, wherein:
the substrate includes an arrangement of electrodes configured to apply an in-plane electric field across the RM guest-host polarizer molecules no later than while performing the polymerization of the RM guest-host polarizer material; and
the electric field aligns the RM guest-host molecules in the substantially planar arrangement.

6. The method of claim 1, wherein the temporary gaseous layer has a pressure that is below, the same as or above an atmospheric pressure.

7. The method of claim 1, further comprising:
applying a magnetic field across the RM guest-host polarizer molecules no later than while performing the polymerization of the RM guest-host polarizer material.

8. The method of claim 1, further comprising:
applying a rubbing process to a non-substrate side of the RM guest-host polarizer material no later than while performing the polymerization of the RM guest-host polarizer material.

9. The method of claim 1, wherein:
a first layer of the RM guest-host polarizer molecules is deposited and polymerized; and
a second layer of the RM guest-host polarizer molecules is deposited on the first layer and polymerized.

10. The method of claim 1, wherein the forming of the RM guest-host polarizer material on the substrate is a deposition process including at least one of:
a slot-die coating process;
an ink-jet printing process;
a dip coating process;
a doctor blade coating process; and
a spin coating process.

11. A method of fabricating a reactive mesogen (RM) guest-host polarizer, the method comprising:
forming an RM guest-host polarizer material on a substrate that promotes a substantially uniform planar alignment configuration of the RM guest-host molecules;
performing first polymerization of the RM guest-host polarizer material at a first temperature, wherein the RM guest-host polarizer material is in a nematic, a smectic A or a smectic C phase, and the guest-host polarizer material adopts the substantially uniform planar alignment configuration at a surface facing away from the substrate;
performing second polymerization of the RM guest-host polarizer material at a second temperature lower than the first temperature, wherein the RM guest-host polarizer material is not in the nematic, the smectic A, or the smectic C phase.

12. The method of claim 11, wherein at least one of the first polymerization and the second polymerization includes a photo-polymerization process.

13. The method of claim 11, wherein:
the substrate includes an arrangement of electrodes configured to apply an in-plane electric field across the RM guest-host polarizer molecules no later than while performing the polymerization of the RM guest-host polarizer material; and
the electric field aligns the RM guest-host molecules in the substantially planar arrangement.

14. The method of claim 11, further comprising:
applying a magnetic field across the RM guest-host polarizer molecules no later than while performing the first or second polymerization of the RM guest-host polarizer material.

15. The method of claim 11, further comprising:
applying a rubbing process to a non-substrate side of the RM guest-host polarizer material no later than while performing the first or second polymerization of the RM guest-host polarizer material.

16. The method of claim 11, wherein the forming of the RM guest-host polarizer material on the substrate is a deposition process including at least one of:
a slot-die coating process;
an ink-jet printing process;
a dip coating process;
a doctor blade coating process; and
a spin coating process.

17. A method of fabricating a reactive mesogen (RM) guest-host polarizer, the method comprising:
forming an RM guest-host polarizer material on a substrate that promotes a substantially uniform planar alignment configuration of the RM guest-host molecules, the substrate having an arrangement of electrodes;
applying an in-plane electric field to the arrangement of electrodes to induce the substantially uniform planar alignment configuration of RM guest-host polarizer molecules in the RM guest-host polarizer material;
performing polymerization of the RM guest-host polarizer material.

18. The method of claim 17, wherein the polymerization of the RM guest-host polarizer material includes a photo-polymerization process.

19. The method of claim 17, further comprising:
applying a magnetic field across the RM guest-host polarizer molecules no later than while performing the polymerization of the RM guest-host polarizer material.

20. The method of claim 17, wherein the forming of the RM guest-host polarizer material on the substrate is a deposition process including at least one of:
a slot-die coating process;
an ink-jet printing process;
a dip coating process;
a doctor blade coating process; and
a spin coating process.
